(19) United States
(12) Patent Application Publication
(10) Pub. No.: US 2023/0318941 A1
(43) Pub. Date: Oct. 5, 2023

(54) SPECIAL QoE MEASUREMENTS DURING RRC CONNECTED STATE MOBILITY

(71) Applicant: Telefonaktiebolaget LM Ericsson (PUBL), Stockholm (SE)

(72) Inventors: Johan Rune, LIDINGÖ (SE); Luca Lunardi, GENOA (IT); Ali Parichehrehteroujeni, LINKÖPING (SE); Filip Barac, HUDDINGE (SE); Cecilia Eklöf, TÄBY (SE)

(21) Appl. No.: 18/040,005

(22) PCT Filed: Aug. 5, 2021
(86) PCT No.: PCT/IB2021/057205

§ 371 Date: Jan. 31, 2023

Related U.S. Application Data
(60) Provisional application No. 63/062,319, filed on Aug. 6, 2020.

(51) Int. Cl. H04L 41/5067; H04L 41/5009

(52) U.S. Cl. CPC H04L 41/5067; H04L 41/5009

(57) ABSTRACT

According to certain embodiments, a method performed by a wireless device comprises determining one or more Quality of Experience (QoE) measurements to perform. The one or more QoE measurements relate to one or more mobility events associated with a connected state of the wireless device. Determining the one or more QoE measurements to perform is based at least in part on a type of the one or more mobility events and/or based at least in part on a state or stage of preparation or execution of the one or more mobility events. The method further comprises performing the one or more QoE measurements.

### TECHNICAL FIELD

Certain embodiments of the present disclosure relate, in general, to wireless communications and, more particularly to Quality of Experience (QoE) measurements related to a mobility event of a wireless device in a connected state.

### BACKGROUND

### Overall Architecture of NG-RAN

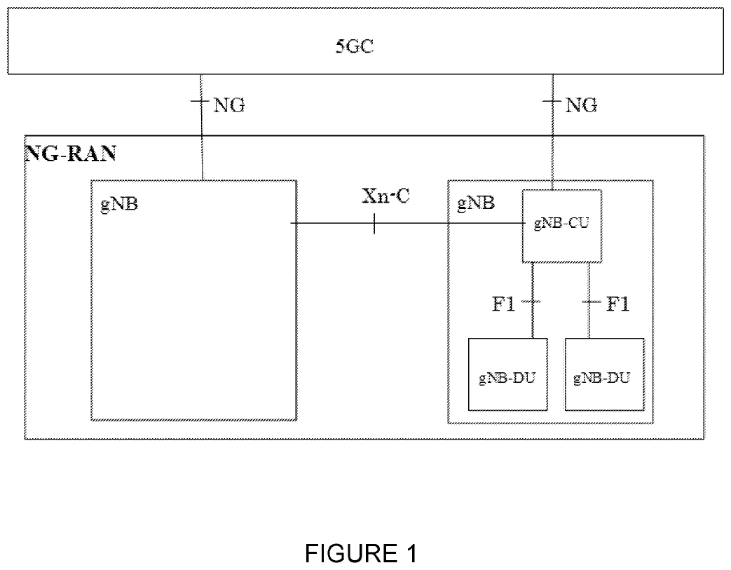

FIG. 1 illustrates an example block diagram of an overall architecture for a Next Generation Radio Access Network (NG-RAN). The NG-RAN comprises a set of radio base stations (referred to as gNBs in New Radio, NR). The gNBs are connected to the 5^{th} Generation (5G) Core Network (5GC) through the Next Generation (NG) interface. Note that the Third Generation Partnership Project (3GPP) Technical Specification (TS) 38.300 specifies that the NG-RAN could also consist of a set of ng-eNBs (where an eNB refers to an Evolved-Universal Terrestrial Radio Access Network IE-UTRAN) NodeB, which is a type of radio base station). An ng-eNB may comprise a Central Unit (CU) (an ng-eNB-CU) and one or more Distributed Units (DUs)(an ng-eNB-DU). An ng-eNB-CU and an ng-eNB-DU connect via a W1 interface. The general principle described n this section also applies to ng-eNB and W1 interface, if not explicitly specified otherwise.

A gNB can support Frequency Division Duplex (FDD) mode, Time Division Duplex (TDD) mode, or dual mode operation. The gNBs can be interconnected through the Xn interface. A gNB may comprise a gNB-CU and one or more gNB-DU(s). A gNB-CU and a gNB-DU connect via an F1 interface. One gNB-DU is connected to only one gNB-CU in FIG. 1. Note that in case of network sharing with multiple cell identities (tell IDs) broadcast, each cell ID associated with a subset of Public Land Mobile Network (PLMNs) corresponds to a gNB-DU and the gNB-CU it is connected to, i.e., the corresponding gNB-DUs share the same physical layer cell resources. Further note that for resiliency, a gNB-DU may be connected to multiple gNB-CUs by appropriate implementation.

The NG, Xn, and F1 interfaces are logical interfaces. For the NG-RAN, for a gNB comprising a gNB-CU and gNB-DUs, the NG and Xn-C interfaces terminate in the gNB-CU. For E-UTRA-NR Dual Connectivity (EN-DC), for a gNB comprising a gNB-CU and gNB-DUs, the S1-U and X2-C interfaces terminate in the gNB-CU. The gNB-CU and connected gNB-DUs are only visible to other gNBs and the SOC as a gNB.

The node hosting user plane part of NR Packet Data Convergence Protocol (PDCP)(for example, gNB-CU, gNB-CU-UP (where UP refers to the User Plane), and for EN-DC, Master eNB (MeNB) or Secondary eNB (SeNB) depending on the bearer split) shall perform user inactivity monitoring and further informs its inactivity or (re)activation to the node having control plane (C-plane or CP) connection towards the core network (e.g., over E1, X2). The node hosting NR Radio Link Control (RLC) (e.g., gNB-DU) may perform user inactivity monitoring and further inform its inactivity or (re)activation to the node hosting control plane, e.g., gNB-CU or gNB-CU-CP.

Uplink (UL) PDCP configuration (i.e., how the user equipment (UE) uses the UL at the assisting node) is indicated via X2-C (for EN-DC). Xn-C (for NG-RAN) and F1-C. Radio Link Outage/Resume for downlink (DL) and/or UL is indicated via X2-U (for EN-DC), Xn-U (for NG-RAN) and F1-U.

The NG-RAN is layered into a Radio Network Layer (RNL) and a Transport Network Layer (TNL) The NG-RAN architecture. i.e., the NG-RAN logical nodes and interfaces between them, is defined as par of the RNL. For each NG-RAN interface (NG, Xn, F1) the related TNL protocol and the functionality are specified. The TNL provides services for user plane transport, signalling transport.

In NG-Flex configuration, each NG-RAN node is connected to all Access and Mobility Management Functions (AMFs) of AMF Sets within an AMF Region supporting at least one slice also supported by the NG-RAN node. The AMF Set and the AMF Region are defined in 3GPP TS 23.501.

If security protection for control plane and user plane data on TNL of NG-RAN interfaces has to be supported, Network Domain Security/Internet Protocol (NDS/IP) 3GPP TS 33.301 shall be applied.

Overall Architecture for Separation of gNB-CU-CP and gNB-CU-UP

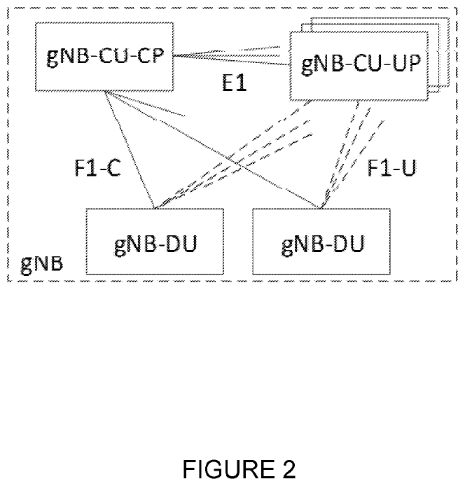

The overall architecture for separation of gNB-CU-CP and gNB-CU-UP is depicted in FIG. 2. A gNB may comprise a gNB-CU-CP, multiple gNB-CU-UPs, and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. In FIG. 2, one gNB-DU is connected to only one gNB-CU-CP, and one gNB-CU-UP is connected to only one gNB-CU-CP Note that for resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP. One gNB-CU-UP can be connected to multiple DUs under the control of the same gNB-CU-CP. Note that the connectivity between a gNB-CU-UP and a gNB-DU is established by the gNB-CU-CP using Bearer Context Management functions. Further note that the gNB-CU-CP selects the appropriate gNB-CU-UP(s) for the requested services for the UE. In case of multiple CU-UPs, they belong to the sane security domain as defined in TS 33.210 Further note that data forwarding between gNB-CU-UPs during intra-gNB-CU-CP handover within a gNB may be supported by Xn-U.

### QoE Background

Quality of Experience (QoE) measurements have been specified for Long-Term Evolution (LTE) and Universal Mobile Telecommunication System (UMTS) The purpose of the application layer measurements is to measure the end user experience when using certain applications. Currently. QoE measurements for streaming services and for MTSI (Multimedia Telephony Service for IP Multimedia Subsystem (IMS)) services are supported in LTE.

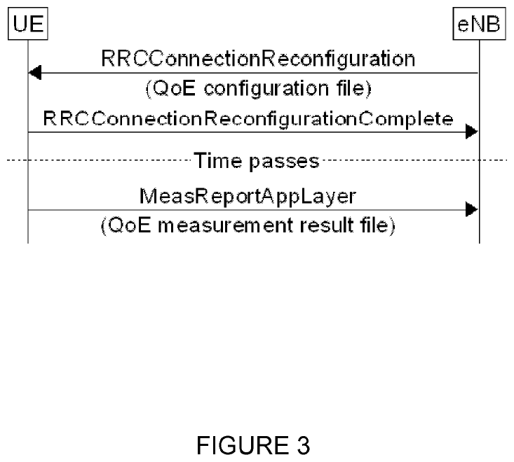

The solutions in LTE and UMTS are similar with the overall principles as follows Quality of Experience Measurement Collection enables configuration of application layer measurements in the UE and transmission of QoE measurement result files by means of Radio Resource Control (RRC) signalling. An application layer measurement configuration received from Operation and Maintenance (OAM) or the Core Network (CN) is encapsulated in a transparent container, which is forwarded to UE in a downlink RRC message. Application layer measurements received from UE's higher layer are encapsulated m a transparent container and sent to network in an uplink RRC message. The result container is forwarded to a Trace Collector Entity (TCE). FIG. 3 shows the RRC signalling flow for QoE measurements in LTE.

A new study item for “Study on NR QoE management and optimizations for diverse services” for NR was approved for 3GPP release 17. The purpose of the study item is to study solutions for QoE measurements in NR. QoE management in NR will not just collect the experience parameters of streaming services but also consider the typical performance requirements of diverse services (e.g., augmented reality/virtual reality AR/VR and Ultra Reliable Low Latency Communication. URLLC). Based on requirements of services, the NR study will also include more adaptive QoE management schemes that enable network intelligent optimization to satisfy user experience for diverse services.

The measurements may be initiated towards the RAN in a management-based manner, i.e., from an Operation and Maintenance (O&M) node in a generic wav for a group of UEs. or they may also be initiated in a signaling-based manner, i.e., initiated from CN to RAN. e.g., for a single UE. The configuration of the measurement includes the measurement details, which are encapsulated in a container that is transparent to RAN.

When initiated via the core network, the measurement is directed towards a specific UE In LTE, the “TRACE REQUEST” S1AP message is used, which carries the configuration information for the measurement the application should perform and directions for how to reach the trace collector entity (TCE) to which the collected measurements should be sent.

The RAN is not aware of when the streaming session as ongoing in the UE and RAN is also not aware of when the measurements are ongoing. It is important for the client analyzing the measurements that the whole session is measured. It is an implementation decision when RAN stops the measurements. Typically, it is done when the UE has moved outside the measured area.

It is beneficial that, if there is a Packet Switched (PS) streaming session, the UE would keep the QoE measurement for the whole session, even during handover situation.

### QoE Measurement in UTRAN

### UTRAN—Application Layer Measurement Capabilities

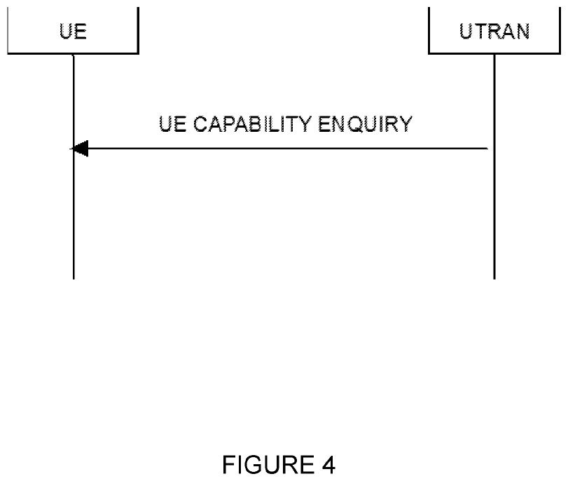

According to 3GPP TS 25.331 v.16.0.0 (2020 Apr. 2). UTRAN can request the UE (via “UE Capability Enquiry”) to report its capability, as shown in FIG. 4. The UE can provide its capability using the “UE Capability Information” RRC message as shown in Figure S. The “UE Capability Information” message can include the “UE radio access capability,” see 3GPP TS 23.331.

The “Measurement Capability” information element (IE) can be used from the UE to transfer to the UTRAN the information related to the capability to perform the QoE measurement collection for streaming services and/or MTSI services. See 3GPP TS 25.331 for an example of the “Measurement Capability” IE.

### UTRAN—QoE Measurement Configuration—RRC Signaling

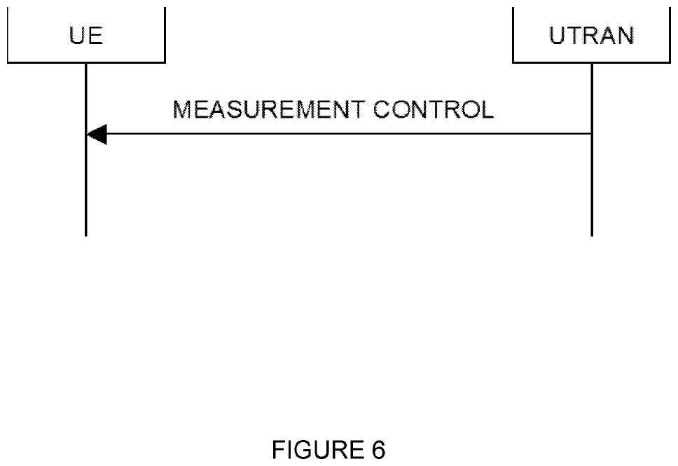

To configure QoE measurement in the UE, the UTRAN can send a “Measurement Control” RRC message containing “Application layer measurement configuration,” as shown in FIG. 6. See 3GPP TS 25.331 for an example of the “Application layer measurement configuration” IE.

### UTRAN—QoE Measurement Reporting—RRC Signaling

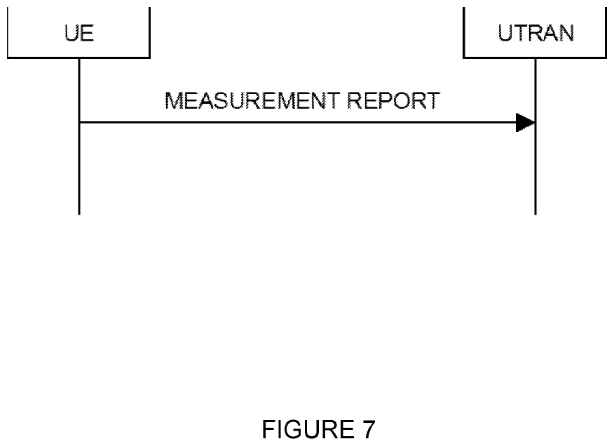

The UE can send QoE measurement results via UTRAN to the Collecting Entity using the “Measurement Report” RRC message and including the “Application layer measurement reporting” IE, as shown in FIG. 7. The UE may also perform Cell Update with came “application layer measurement report available” in order to initiate the transfer of application layer measurement report. Signalling radio bearer RB4 shall be used for the MEASUREMENT REPORT message carrying the IE “Application layer measurement reporting.” See 3GPP TS 25.331 for an example of the “Application layer measurement reporting” IE.

### QoE Measurement in E-UTRAN

### E-UTRAN—Application Layer Measurement Capabilities

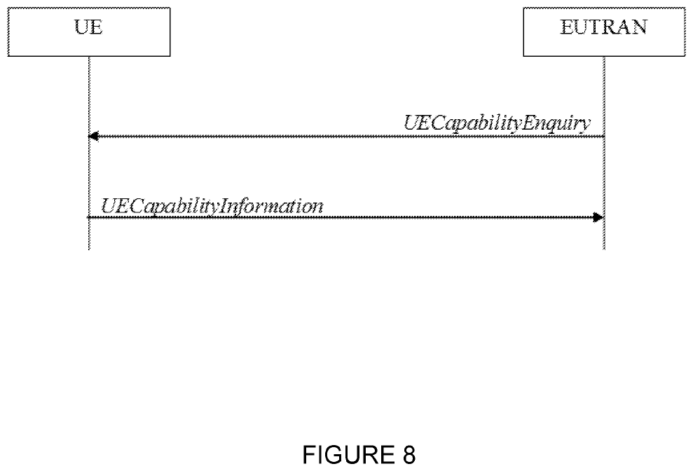

For E-UTRAN, the UE capability transfer is used to transfer UE radio access capability information from the UE to E-UTRAN, as shown in FIG. 8. The UE-EUTRA-Capability IE is used to convey the E-UTRA UE Radio Access Capability Parameters and the Feature Group indicators for mandatory features to the network.

In the response message “UECapabilityInformation”, the UE can include the “UE-EUTRA-Capability” IE. The “UE-EUTRA-Capability” IE mat include the UE-EUTRA-Capability-v 1530-IE which can be used by the UE to indicate whether the UE supports or not QoE Measurement Collection for streaming services and/or MTSI services, as detailed in the “MeasParameters-v1530” encoding below.

The contribution CR 4297 (R2-2004624) for 3GPP TS 36.331 v16.0.0 at the 3GPP TSG RAN2 Meeting #110 proposed an extension of the “UE-EUTRA-Capability” IE that, within the “UE-EUTRA-Capability-v16xy-IE” may include a “measParameters-v16xy” comprising the qoc-Extensions-r16 IF. The qoe-Extensions-r16 IE may be used to indicate whether the UE supports the release 16 extensions for QoE Measurement Collection. i.e., if the UE supports more than one QoE measurement type at a time and if the UE supports the signaling of withinArea, sessionRecordingIndication, QoE-Reference, temporaryStopQoE and restartQoE. The QoE-Reference contains the parameter QoE Reference as defined in 3GPP TS 28.405.

### E-UTRAN—Application Layer Measurement Reporting

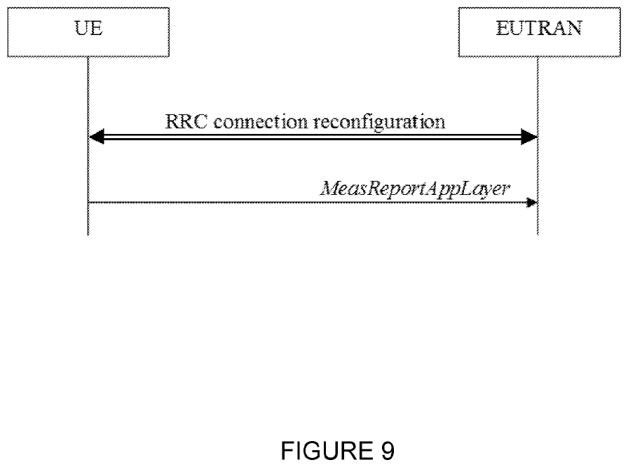

The purpose of the “Application layer measurement reporting” procedure described in 3GPP TS 36.331 and shown in FIG. 9 is to inform E-UTRAN about application layer measurement report. A UE capable of application layer measurement reporting in RRC_CONNECTED may initiate the procedure when configured with application layer measurement, i.e., when measConfigAppLayer has been configured by E-UTRAN.

### E-UTRAN—QoE Measurement Configuration Setup and Release—RRC Signaling

The RRCConnectonReconfiguration message is used to reconfigure the UE to setup or release the UE for Application Layer measurements. This is signaled in the measConfigAppLayer-15 IE within the “OtherConfig” IE.

The setup includes the transparent container measConfigAppLayerContainer which specifies the QoE measurement configuration for the Application of interest and the serviceType IE to indicates the Application (or service) for which the QoE measurements are being configured. Supported services are streaming and MTSI.

The contribution CR 4297 (R2-2004624) for 3GPP TS 36.331 v16.0.0 at the 3GPP TSG RAN2 Meeting #110 proposed to extend the QoE measurement configuration.

The measConfigAppLayerToAddModList-r16 may be used to add or modify multiple QoE measurement configurations (up to maxQoE-Measurement-r16). The measConfigAppLayerToReleaseList-r16 IE may be used to remove multiple QoE measurement configuration (up to maxQoE-Measurement-r16).

The OtherConfig IE related to measConfigAppLayer-r15, measConfigAppLayerToAddModList-r16, and/or measConfigApplayerToReleaseList-r16 may include a Service Type. The Service Type contains the service type of a certain QoE measurement as defined in TS 28.405.

For E-UTRAN, an example of desired UE behavior at reception of the “OtherConfig” IE in the RRCReconfiguration message is described in CR 4297 (R2-20044624).

### E-UTRAN—QoE Measurement Reporting—RRC Signaling

As specified in 3GPP TS 36.331, the MeasReportAppLayer RRC message is used by the UE to send to the E-UTRAN node the QoE measurement results of an Application (or service). The service for which the report is being sent is indicated in the “servceType” IE.

The contribution CR 4297 (R2-2004624) for 3GPP TS 36.331 v16.0.0 at the 3GPP TSG RAN2 Meeting #110 proposed to extend the MeasReportAppLayer IEs introducing a QoE reference comprising the PLMN identity and the identifier of the QoE Measurement Collection.

The MeasReportAppLayer message may be sent using Signalling Radio Bearer, SRB4.

For E-UTRAN, an example of desired UE behavior for Application layer measurement reporting is described in CR 4297 (R2-2004624).

### AT Commands

Information can be transferred between different layers in the UE by means of so-called AT commands. AT commands are used for transferring information between the application layer and the AS layer (Access Stratum layer, aka radio layer) in the UE. The AT commands are specified in 3GPP TS 27.007 The existing AT commands for QoE measurements are shown in 3GPP TS 27007 Table 8.78-1, “+CAPPLEVMC parameter command syntax” (Application level measurement configuration) and Table 8.79-1. “+CAPPLEVMR action command syntax” (Application level measurement report). The AT commands N % ere implemented when specifying QoE measurements for LTE

### Mobility in RRC_CONNECTED State in NR—Handover

### The Handover Procedure

Mobility in RRC_CONNECTED state is also known as handover. The purpose of handover is to move the UE from a source cell (controlled by a source node/gNB using a source radio connection (also known as source cell connection), to a target cell (controlled by a target node/gNB), using a target radio connection (also known as target cell connection). The target radio connection is associated with a target cell controlled by the target access node. So, in other words, during a handover, the UE moves from the source cell to a target cell. Sometimes the source access node or the source cell is referred to as the “source.” and the target access node or the target cell is sometimes referred to as the “target.” The source access node and the target access node may also be referred to as the source node and the target node, the source radio network node and the target radio network node or the source gNB and the target gNB.

In some cases, the source access node and target access node are different nodes, such as different gNBs. These cases are also referred to as inter-node or inter-gNB handover In other cases, the source access node and target access node are the same node, such as the same gNB. These cases are also referred to as intra-node or intra-gNB handover and include the case when the source and target cells are controlled by the same access node In yet other cases, handover is performed within the same cell, e.g., for the purpose of refreshing the security keys, and thus also within the same access node controlling that cell. These cases are referred to as intra-cell handover.

It should therefore be understood that the source access node and target access node each refers to a role served by a given access node during a handover of a specific LIE. For example, a given access node may serve as source access node during handover of one UE, while it also serves as the target access node during handover of another UE. And, in case of an intra-node or intra-cell handover of a given UE, the same access node serves both as the source access node and target access node for that UE.

An inter-node handover can further be classified as an Xn-based or NG-based handover depending on whether the source and target node communicate directly using the Xn interface or indirectly via the core network using the NG interface.

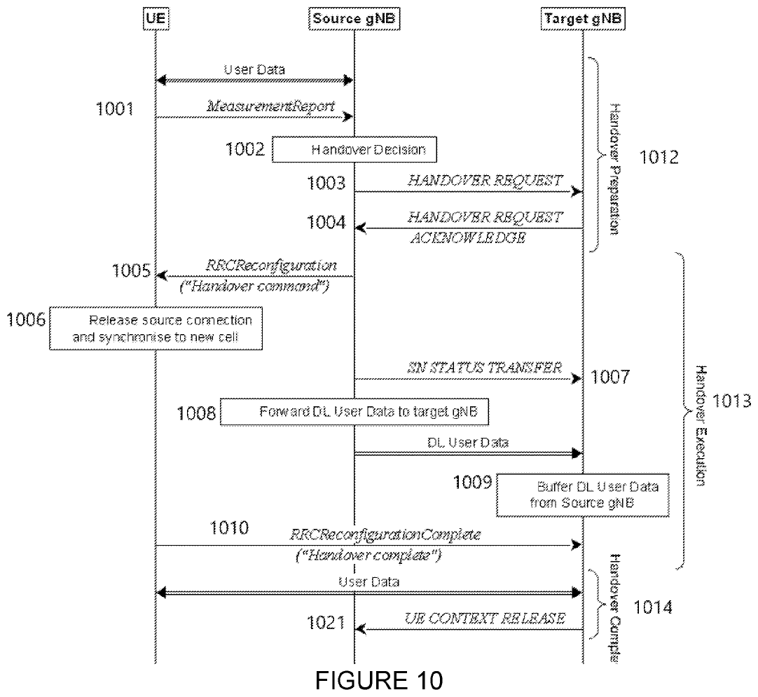

FIG. 10 shows the signaling flow between the LE and source and target access node during an Xn-based inter-node handover in NR. Note that from the UE's point of view, the procedure is the same also for intra-node handover cases, where the source and target cells are controlled by the same gNB.
1001-02 The UE and source gNB have an established connection and is exchanging user data Due to some trigger, e.g., a measurement report from the UE, the source gNB decides to handover the UE to the target gNB.
1003. The source gNB sends a HANDOVER REQUEST message to the target gNB with necessary information to prepare the handover at the target side. The information includes among other things the current source configuration and the LE capabilities.
1004. The target gNB prepares the handover and responds with a HANDOVER REQUEST ACKNOWLEDGE message to the source gNB, which includes the handover command (a RRCReconfiguration message containing the reconfigurationWithSync field) to be sent to the UE. The handover command includes information needed by the UE to access the target cell, e.g., random access configuration, a new Cell-Radio Network Temporary Identifier (C-RNT1) assigned by the target access node and security parameters enabling the UE to calculate the target security key so the UE can send the handover complete message (a RRCReconfigurationComplete message).

If the target gNB does not support the release of RRC protocol which the source gNB used to configure the UE, the target gNB may be unable to comprehend the UE configuration provided by the source eNB in the HANDOVER REQUEST. In this case, the target gNB can use so called “full configuration” to reconfigure the UE for handover. Full configuration option includes an initialization of the radio configuration, which makes the procedure independent of the configuration used in the source cell. Otherwise the target node uses so called “delta configuration” where only the delta to the radio configuration in the source cell is included in the handover command. Delta configuration typically reduces the size of the handover command which increases the speed and robustness of the handover.
1005. The source gNB triggers the handovers by sending the handover command received from the target node in the previous step to the UE.
1006. Upon reception of the handover command the UE releases the connection to the old cell before synchronizing and connecting to the new cell.
1007-09. The source gNB stops scheduling any further DL or UL data to the UE and sends a SN STATUS TRANSFER message to the target gNB indicating the latest PDCP SN transmitter and receiver status. The source node now also starts to forward User Data to the target node, which buffers this data for now.
1010. Once the UE has completed the random access to the target cell, the UE sends the handover complete to the target gNB.
1011. Upon receiving the handover complete message, the target node can start exchanging user data with the UE. The target node also requests the AMF to su itch the DL data path from the UPF from the source node to the target node (not shown) Once the path switch is completed the target node sends the UE CONTEXT RELEASE message to the source node.

### RRM Measurement Framework

Handover in NR is network-controlled (where the decision to handover a UE to a new cell is made by the gNB controlling the UE's serving cell), but UE assisted in the sense that it is supported by measurement reports from the UE, containing results of channel quality measurements the UE performs on the neighbor cells as well as the serving cell. The measurements the UE performs, the contents of the measurement reports and the conditions for when to transmit measurement reports are configured by the serving gNB by means of an RRCReconfiguration message.

A measurement configuration is identified by a measurement identity (Meas/d, which is associated with one measurement object (MeasObjectNR) and one measurement report configuration (ReportConfigNR). The network can configure a UE with multiple measurement configurations, each identified by a unique measurement identity. This means that multiple measurement report configurations may be linked to one measurement object and vice versa, wherein each combination requires its own measurement identity.

The measurement object contains various information of the measurements to be performed, including the carrier frequency, cell list, the measurement quantity (e.g., Reference Signal Received Power (RSRP), Reference Signal Received Quality (RSRQ). Signal-to-interference-plus-noise ratio (SINR) or Received Signal Strength Indicator (RSSI)), the reference signal to measure on (synchronization signal block (SSB) or Channel State Information-Reference Signal (CSI-RS)), SSB Measurement Timing Configuration (SMTC), etc.

The measurement report configuration contains the condition for sending measurement report(s) and measurement report content related aspects. The condition for sending measurement report(s) may be that an event if fulfilled, but a UE can also be configured to send periodical measurement reports. The specified events that mat trigger sending of measurement report(s) are:
Event A1: Serving becomes better than absolute threshold;
Event A2: Serving becomes worse than absolute threshold;
Event A3: Neighbour becomes amount of offset better than Primary Cell (PCell)/Primary Secondary Cell (PSCell);
Event A4: Neighbour becomes better than absolute threshold;
Event A5: PCell/PSCell becomes worse than absolute threshold1 AND Neighbour/Secondary Cell (SCell) becomes better than another absolute threshold2;
Event A6: Neighbour becomes amount of offset better than SCell
Event 11: Interference becomes higher than absolute threshold (For event 11, measurement reporting event is based on cross-link interference (CLI) measurement results, which can either be derived based on Sounding Reference Signal (SRS)-RSRP or CLI-RSSL)

Of the above events, events A1-A5 are the most important ones for handover and event A6 is also important for change of SCell.

### UE Mobility History Information

According to TS 38.331 v16.1.0 (2020-07-24), the UE may store information about the 16 latest visited cells in UE variable VarMobilitYHistoryReport. The variable contains the identification of the cells and the time spent in the cells.

The VarMobilitYHistoryReport includes the VisitedCellInfoList IE, which includes the mobility history information of maximum of 16 most recently visited cells or time spent outside NR. The most recently visited cell is stored first in the list. The list includes cells visited in RRC_IDLE, RRC_INACTIVE and RRC_CONNECTED states for NR and RRC_IDLE and RRC_CONNECTED for E-UTRA.

### Dual Connectivity in LTE

E-UTRAN supports Dual Connectivity (DC) operation whereby a multiple Receiver/transmitter (Rx/Tx) UE in RRC_CONNECTED is configured to utilize radio resources provided by two distinct schedulers, located in two eNBs connected via a non-ideal backhaul over the X2 interface (see 3GPP 36.300).

eNBs involved in DC for a certain UE may assume two different roles an eNB may either act as an MN (Master node or MeNB) or as an SN (Secondary node or SeNB). In DC a UE is connected to one MN and one SN.

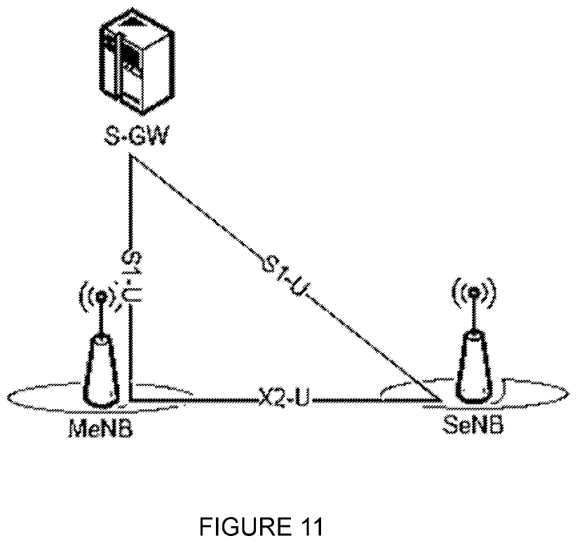

For LTE DC, two different user plane architectures are allowed (3GPP TS 36.300): one in which the S1-U only terminates in the MeNB and the user plane is transferred from MeNB to SeNB using the X2-U, and a second architecture where the S1-U can terminate in the SeNB. FIG. 11 illustrates an example of User Plane connectivity of eNBs involved in Dual Connectivity.

In LTE DC, the radio protocol architecture that a particular bearer uses depends on how the bearer is setup. Three bearer types exist:
MCG (Master Cell Group) bearer the S1-U connection for the corresponding bearer(s) to the Serving Gateway (S-GW) is terminated in the MeNB The SeNB is not involved in the transport of user plane data for this type of bearer(s) over the Uu.
Split bearer: the S1-U connection to the S-GW is terminated in the MeNB. PDCP data is transferred between the MeNB and the SeNB via X2-U. The SeNB and MeNB are involved in transmitting data of this bearer type over the Uu.
SCG (Secondary Cell Group) bearer: the SeNB is directly connected with the S-GW via S1-U. The MeNB is not involved in the transport of user plane data for this type of bearer(s) over the Uu.

If only MCG and split bearers are configured, there is no S1-U termination in the SeNB.

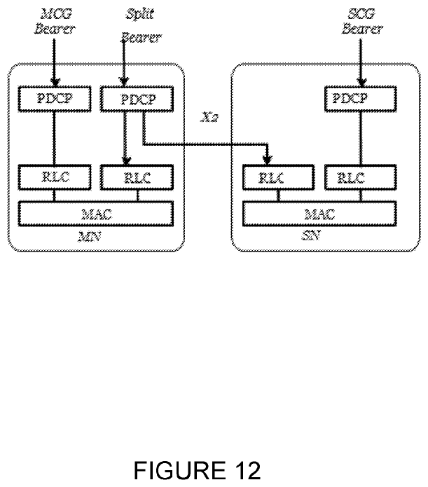

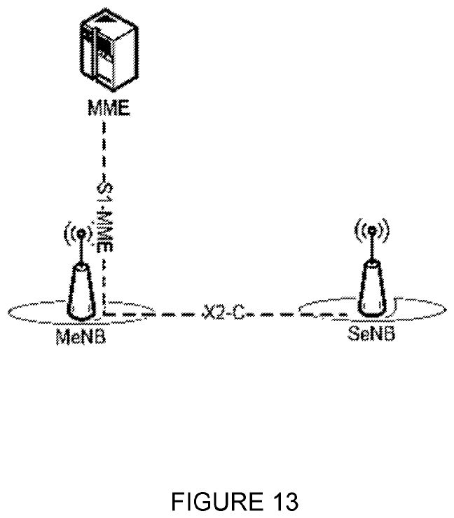

FIG. 12 illustrates an example of an LTE DC User Plane. FIG. 13 illustrates an example of Control Plane connectivity of eNBs involved in Dual Connectivity. In the control plane:
signaling towards the Mobility Management Entity (MME) is performed by means of S1 interface signaling. There is only one S1-MME connection per DC UE, between the MeNB and the MME.
Inter-eNB control plane signaling for DC is performed by means of X2 interface signaling.
RRC is located in MeNB and SRBs (Signaling Radio Bearers) are always configured as MCG bearer type and therefore only use the radio resources of the MN.

Note that in Dual Connectivity, it is also possible to support CA (Carrier Aggregation) in each cell group (i.e., MCG and SCG) That is, the MCG could be comprised of more than one cells working in CA, and the SCG could also be comprised of more than one cells working in CA The primary cell in the MCG is known as the PCell, while the primary cell of the SCG is known as the PSCell.

### Multi-Radio Dual Connectivity

Multi-Radio Dual Connectivity (MR-DC) is a generalization of the Intra-E-UTRA Dual Connectivity (DC) and it is described in 3GPP TS 37.340 y 16.2.0 (2020-07-24).

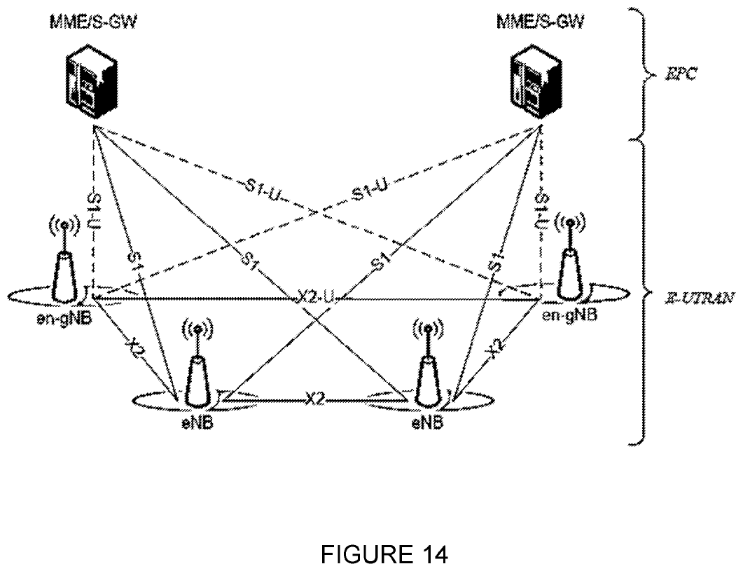

For the case of MR-DC with the Evolved Packet Core (EPC). E-UTRAN supports MR-DC via E-UTRA-NR Dual Connectivity (EN-DC), in which a UE is connected to one eNB that acts as Master Node (MN) and one en-gNB that acts as a Secondary Node (SN). The EN-DC overall architecture is shown in FIG. 14.

For the case of MR-DC with the 5GC, the following options are standardized in 3GPP TS 37.340:
E-UTRA-NR Dual Connectivity (NGEN-DC): a UE is connected to one ng-eNB that acts as a MN and one gNB that acts as a SN
NR-EUTRA Dual Connectivity (NE-DC): a UE is connected to one gNB that acts as a MN and one ng-eNB that acts as a SN
NR-NR Dual Connectivity (NR-DC): a UE is connected to one gNB that acts as a MN and one gNB that acts as a SN. In addition. NR-DC can also be used when a UE is connected to two gNB-DUs, one serving the MCG and the other serving the SCG, connected to the same gNB-CU, acting both as a MN and as a SN.

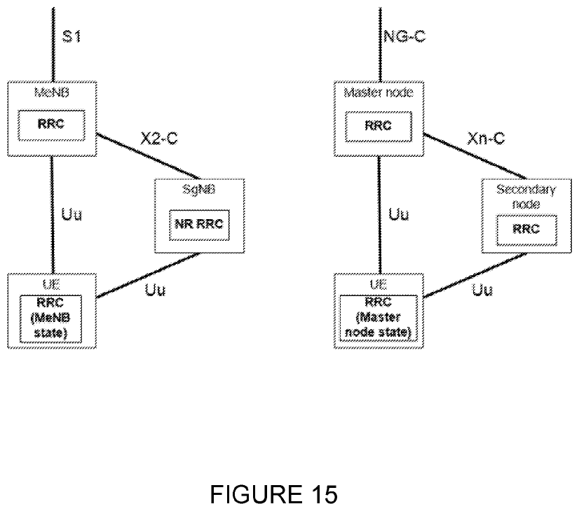

For MR-DC, the UE has a single RRC state, based on the MN RRC and a single C-plane connection towards the Core Network, as shown in FIG. 15 (FIG. 15 shows a control plane architecture for EN-DC (left) and MR-DC with 5GC (right).

RRC Protocol Data Units (PDUs) generated by the SN can be transported via the MN to the UE The MN always sends the initial SN RRC configuration via MCG SRB (SRB1), but subsequent reconfigurations may be transported via MN or SN. When transporting RRC PDU from the SN, the MN does not modify the UE configuration provided by the SN.

In E-UTRA connected to EPC, at initial connection establishment SRB1 uses E-UTRA PDCP. If the UE supports EN-DC, regardless whether EN-DC is configured or not, after initial connection establishment, MCG SRBs (SRB1 and SRB2) can be configured by the network to use either E-UTRA PDCP or NR PDCP (cither SRB1 and SRB2 are both configured with E-UTRA PDCP, or they are both configured with NR PDCP). Change from E-UTRA PDCP to NR PDCP (or vice-versa) is supported via a handover procedure (reconfiguration with mobility) or, for the initial change of SRB1 from E-UTRA PDCP to NR PDCP, with a reconfiguration without mobility before the initial security activation.

If the SN is a gNB (i.e., for EN-DC. NGEN-DC and NR-DC), the UE can be configured to establish a SRB with the SN (SRB3) to enable RRC PDUs for the SN to be sent directly between the UE and the SN. RRC PDUs for the SN can only be transported directly to the UE for SN RRC reconfiguration not requiring any coordination with the MN Measurement reporting for mobility within the SN can be done directly from the UE to the SN if SRB3 is configured.

Split SRB is supported for all MR-DC options, allowing duplication of RRC PDUs generated by the MN, via the direct path and via the SN. Split SRB uses NR PDCP. This version of the specification does not support the duplication of RRC PDUs generated by the SN via the MN and SN paths.

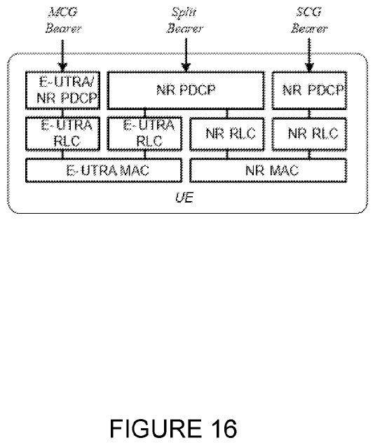

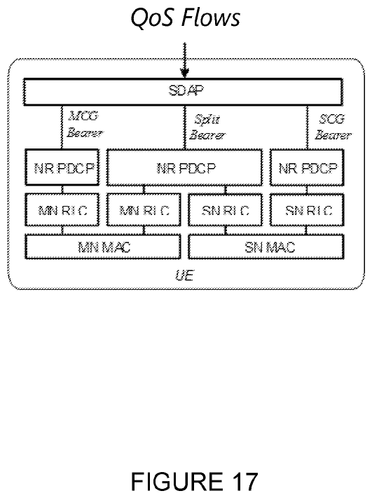

In the User Plane (UP) for MR-DC, from a UE perspective, three bearer types exist: MCG bearer. SCG bearer and split bearer. These bearer types are shown in FIG. 16 for MR-DC with EPC and in FIG. 17 for MR-DC with 5GC (NGEN-DC, NE-DC and NR-DC).

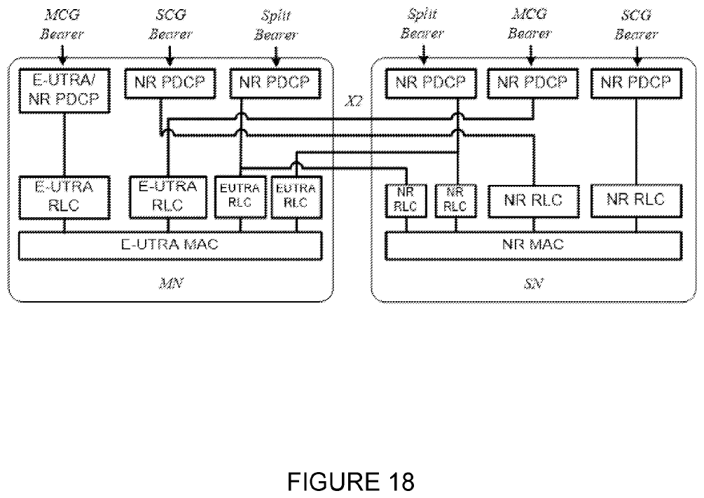

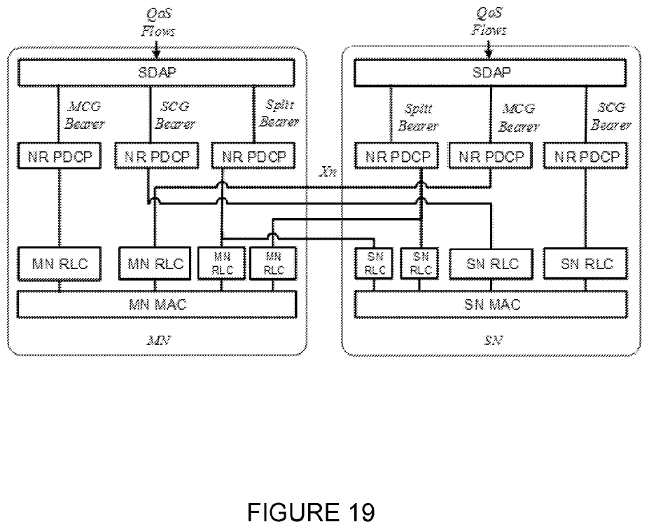

From a network perspective, each bearer (MCG, SCG and split bearer) can be terminated either in MN or in SN. Network side protocol termination options are shown in FIG. 18 for MR-DC with EPC (EN-DC) and in FIG. 19 for MR-DC with 5GC′ (NGEN-DC, NE-DC and NR-DC).

### SUMMARY

There currently exist certain challenge(s). For example, the current QoE measurement framework does not take into account that particular events may call for special QoE measurements, e.g., special aspects to be measured, in order for the reported QoE measurement results to be really useful for the network in terms of Self-Optimized Network (SON) related actions triggered by received QoE measurement reports. One such type of event includes various RRC_CONNECTED state mobility events, including at least handover, Dual Active Protocol Stack (DAPS) handover, Conditional Handover, SCell addition, SCell change, PSCell change, conditional PSCell change (CPC) and master node/secondary node role switch.

Another challenge in QoE management during mobility is that the control of the area that UE has to perform the measurement is done per handover basis between RAN nodes In fact, every time that a handover preparation signal is sent to a target node, the target cell is checked by the source node to see if it is in the area in which the QoE measurement is configured to be performed by the UEs.

Certain aspects of the present disclosure and their embodiments may provide solutions to these or other challenges In brief, certain embodiments of the present disclosure extend the current QoE measurement configuration framework with further QoE measurement variants related to RRC_CONNECTED state mobility events, both in terms of the data that is collected (and reported) and in terms of when the measurement data is collected. e.g., what triggers the measurement data collection. In particular, this includes collecting relevant data (i.e., data the network may utilize, e.g., for SON purposes, such as network performance diagnostics, identification of problematic network configurations, network configuration optimizations, and increased awareness of the users' experienced service quality) during RRC_CONNECTED state mobility events. e.g., handovers.

Certain embodiments include measurement data related to the performance of the execution of a handover (or other RRC_CONNECTED state mobility event) and consequences that the execution of the handover (or other RRC_CONNECTED state mobility event) has on other performance aspects relevant for the user's QoE, such as handover interruption time, change of data rate in conjunction with a mobility event (e.g., the difference in data rate before and after the mobility event), buffer related data (such as change of buffer content size), measured latency or jitter (as further discussed in the Additional Explanation section below).

In addition, the solution includes the possibilty to configure a UE to suspend the QoE measurements while an RRC_CONNECTED state mobility event is ongoing.

In addition, in case of DAPS handover, the solution includes a possibility for the network to configure a UE with different options for which link (source link, target link or both) to measure on while the DAPS handover is ongoing and the UE is connected to both the source and the target cell.

Yet another aspect of the solution is that the network may configure the UE with special QoE measurement reporting configuration(s) to be used for the QoE measurement data collected in conjunction with RRC CONNECT) state mobility events.

From the UE's perspective, the solution includes receiving the above described QoE measurement configuration(s) related to collection of QoE measurement data in conjunction with RRC_CONNECTED state mobility events and/or reporting of the collected QoE measurement data.

There are, proposed herein, various embodiments which address one or more of the issues disclosed herein.

According to certain embodiments, a method performed by a w ireless device comprises determining one or more QoE measurements to perform. The one or more QoE measurements relate to one or more mobility events associated with a connected state of the wireless device. Determining the one or more QoE measurements to perform is based at least in part on a type of the one or more mobility events and/or based at least in part on a state or stage of preparation or execution of the one or more mobility events. The method further comprises performing the one or more QoE measurements.

According to certain embodiments, a wireless device comprises power supply circuitry and processing circuitry. The power supply circuitry is configured to supply power to the wireless device. The processing circuitry is configured to determine one or more QoE measurements to perform. The one or more QoE measurements relate to one or more mobility events associated with a connected state of the wireless device. Determining the one or more QoE measurements to perform is based at least in part on a type of the one or more mobility events and/or based at least in part on a state or stage of preparation or execution of the one or more mobility, events. The processing circuitry is further configured to perform the one or more QoE measurements.

Certain embodiments of the above-described method and/or wireless device may include one or more of the following features:

Certain embodiments obtain configuration information from the network. The configuration information indicates at least one QoE measurement to be performed by the wireless device. The configuration information is obtained prior to performing the one or more QoE measurements.

In certain embodiments, at least one of the one or more mobility events is one of: handover, DAPS handover, Conditional Handover, SCell addition. Scell change, PSCell change. CPC, and master node/secondary node role switch.

Certain embodiments suspend the one or more QoE measurements during at least a part of the one or more mobility events Certain embodiments resume the one or more QoE measurements based at least in part on the state or stage of the one or more mobility events.

In certain embodiments, at least one of the one or more mobility events is a handover during which the wireless device connects to a source cell via a source link and to a target cell via a target link. Certain embodiments determine whether to perform the one or more QoE measurements on the source link, the target link, or both.

Certain embodiments send one or more QoE measurement reports to a network. The one or more QoE measurement reports are based on the one or more QoE measurements.

Certain embodiments receive optimization information from the network and apply the optimization information. The optimization information is based on the one or more QoE measurement reports sent to the network.

According to certain embodiments, a method comprises determining configuration information indicating one or more QoE measurements to be performed by a wireless device. The one or more QoE measurements relate to one or more mobility events associated with a connected state of the wireless device. The configuration information indicates which QoE measurements the wireless device is to perform depending at least in part on a type of the one or more mobility events and/or depending at least in part on a state or stage of preparation or execution of the one or more mobility events. The method further comprises sending the configuration information to the wireless device.

According to certain embodiments, a network node comprises a power supply circuitry and processing circuitry. The power supply circuitry is configured to supply power to the network node. The processing circuitry is configured to determine configuration information indicating one or more QoE measurements to be performed by a wireless device. The one or more QoE measurements relate to one or more mobility events associated with a connected state of the wireless device. The configuration information indicates which QoE measurements the wireless device is to perform depending at least in part on a type of the one or more mobility events and/or depending at least in part on a state or stage of preparation or execution of the one or more mobility events. The processing circuitry is further configured to send the configuration information to the wireless device Certain embodiments of the above-described method and/or network node may include one or more of the following features.

In certain embodiments, at least one of the one or more mobility events is one of: handover. DAPS handover, Conditional Handover. SCell addition, SCell change, PSCell change, conditional PSCell change (CPC), and master node/secondary node role switch.

Certain embodiments send the wireless device an instruction to suspend the one or more QoE measurements during at least a part of the one or more mobility events. Certain embodiments send the wireless device a duration timer associated with the instruction to suspend the one or more QoE measurements. Certain embodiments send the wireless device an instruction to resume the one or more QoE measurements based at least in part on the state or stage of the one or more mobility events.

In certain embodiments, at least one of the one or more mobility events is a handover during which the wireless device connects to a source cell via a source link and to a target cell via a target link. The configuration information indicates whether to perform the one or more QoE measurements on the source link, the target link, or both.

Certain embodiments send the wireless device information indicating a reporting format for the wireless device to use when sending one or more QoE measurement reports to the network.

Certain embodiments receive one or more QoE measurement reports from the wireless device. The one or more QoE measurement reports based on the one or more QoE measurements performed by the wireless device Certain embodiments use the one or more QoE measurement reports received from the wireless device. For example, certain embodiments use the one or more QoE measurement reports received from the wireless device for one or more of: self-optimizing network (SON) purposes, network performance diagnostics, identification of problematic network configurations, network configuration optimizations, and increased awareness of the users' experienced service quality.

According to certain embodiments, a computer program comprises instructions which when executed on a computer perform any of the steps of any of the above-described methods (e.g., methods performed by a wireless device or methods performed by a network node).

According to certain embodiments, a computer program product comprises a computer program. The computer program comprises instructions which when executed on a computer perform any of the steps of any of the abo e-described methods (e.g., methods performed by a wireless device or methods performed by a network node).

According to certain embodiments, a non-transitory computer-readable storage medium comprises a computer program. The computer program comprising instructions which when executed on a computer perform any of the steps of any of the above-described methods (e.g., methods performed by a wireless device or methods performed by a network node).

Certain embodiments may provide one or more of the following technical advantage(s). For example, in certain embodiments, the network can obtain more data, and data that is more relevant during certain critical network operation events (such as handover), which it can utilize for improving the network and the operation of the network, e.g., measurement data to be used for SON purposes, such as network performance diagnostics, identification of problematic network configurations, network configuration optimizations, and increased awareness of the users' experienced service quality.

### BRIEF DESCRIPTION

For a more complete understanding of the disclosed embodiments and their features and advantages, reference is now made to the following description, taken in conjunction with the accompanying drawings, in which.

FIG. 1 illustrates an example block diagram of an overall architecture for an NG-RAN.

FIG. 2 illustrates an example block diagram of an overall architecture for separation of gNB-CU-CP and gNB-CU-UP.

FIG. 3 illustrates an example signal flow for QoE measurement collection in LTE.

FIG. 4 illustrates an example signal flow for a UE capability inquiry procedure in UTRAN.

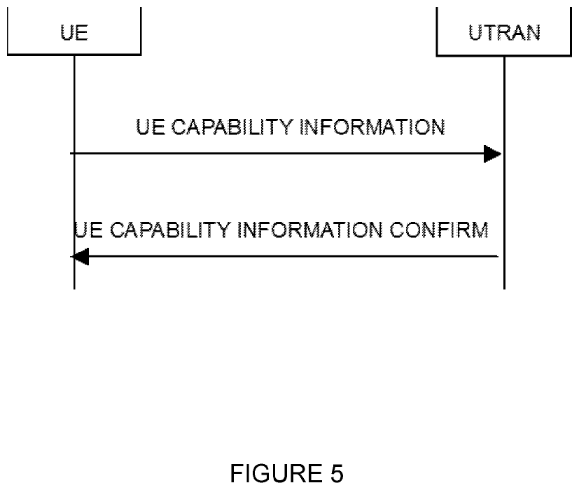

FIG. 5 illustrates an example signal flow for transmission of UE capability information in U TRAN.

FIG. 6 illustrates an example signal flow for measurement control for a normal case in UTRAN.

FIG. 7 illustrates an example signal flow for a measurement report for a normal case in UTRAN.

FIG. 8 illustrates an example of signal flow for a UE capability transfer in E-UTRAN.

FIG. 9 illustrates an example signal flow for application layer measurement reporting in E-UTRAN.

FIG. 10 illustrates an example signal flow for a “Legacy” Rel-15 NR inter-node handover.

FIG. 11 illustrates an example block diagram for User Plane connectivity of eNBs involved in Dual Connectivity.

FIG. 12 illustrates an example block diagram for Dual Connectivity in the User Plane (UP) for LTE.

FIG. 13 illustrates an example block diagram for Control Plane connectivity of eNBs involved in Dual Connectivity.

FIG. 14 illustrates an example block diagram for an EN-DC overall architecture.

FIG. 15 illustrates an example block diagram of a control plane architecture for EN-DC (left) and MR-DC with 5GC (right).

FIG. 16 illustrates an example block diagram for a radio protocol architecture for MCG. SCG and split bearers from a UE perspective in MR-DC with EPC (EN-DC).

FIG. 17 illustrates an example block diagram for a radio protocol architecture for MCG, SCG and split bearers from a IE perspective in MR-DC with SOC (NGEN-DC, NE-DC and NR-DC).

FIG. 18 illustrates an example block diagram for network-side protocol termination options for MCG, SCG and split bearers in MR-DC with EPC (EN-DC).

FIG. 19 illustrates an example block diagram for network-side protocol termination options for MCG, SCG and split bearers in MR-DC with 5GC (NGEN-DC, NE-DC and NR-DC).

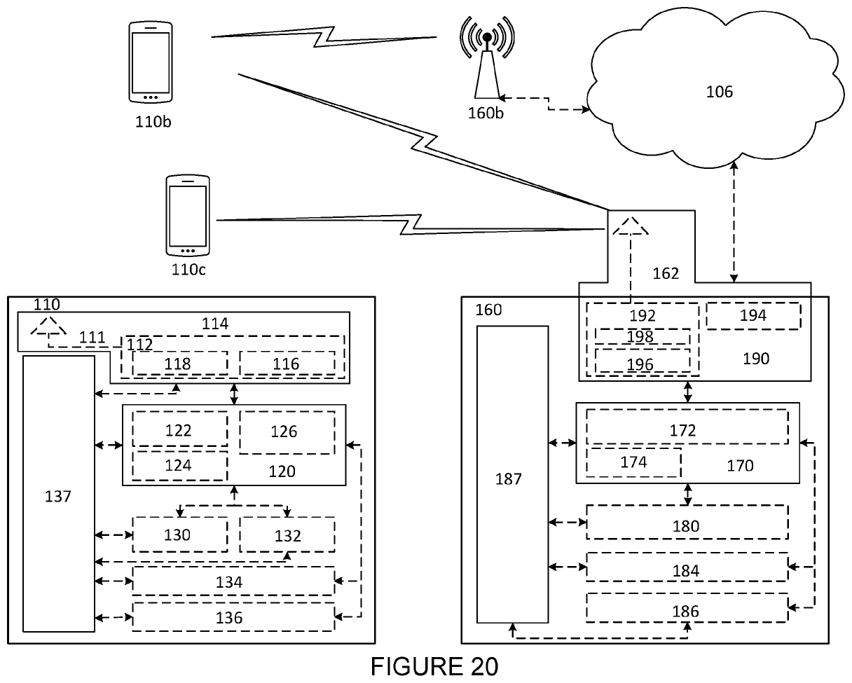

FIG. 20 illustrates an example block diagram of a wireless network in accordance with some embodiments.

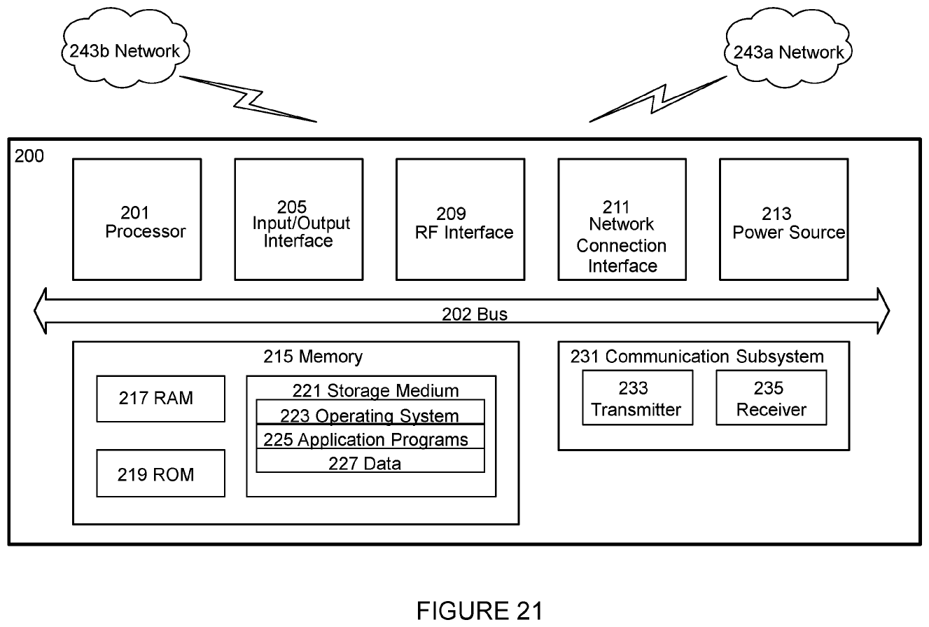

FIG. 21 illustrates an example block diagram of a User Equipment in accordance with some embodiments.

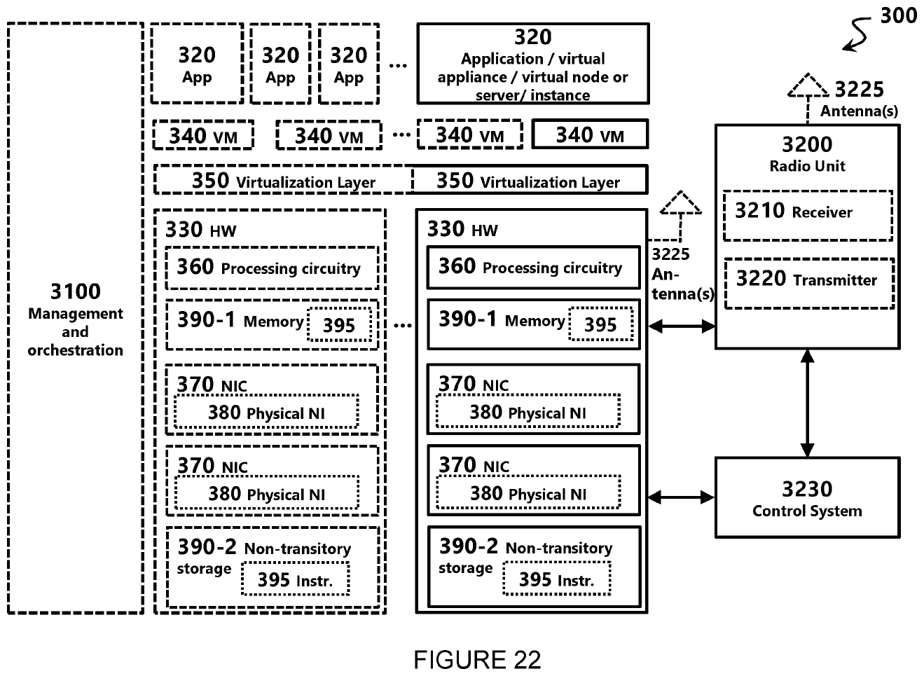

FIG. 22 illustrates an example block diagram of a virtualization environment in accordance with some embodiments.

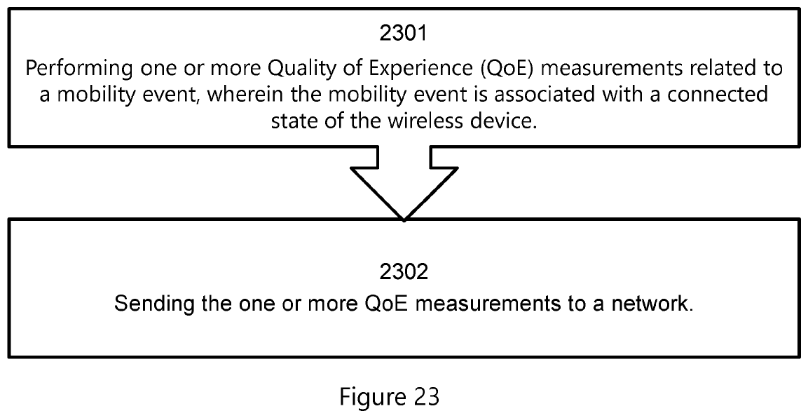

FIG. 23 illustrates an example method in accordance with some embodiments.

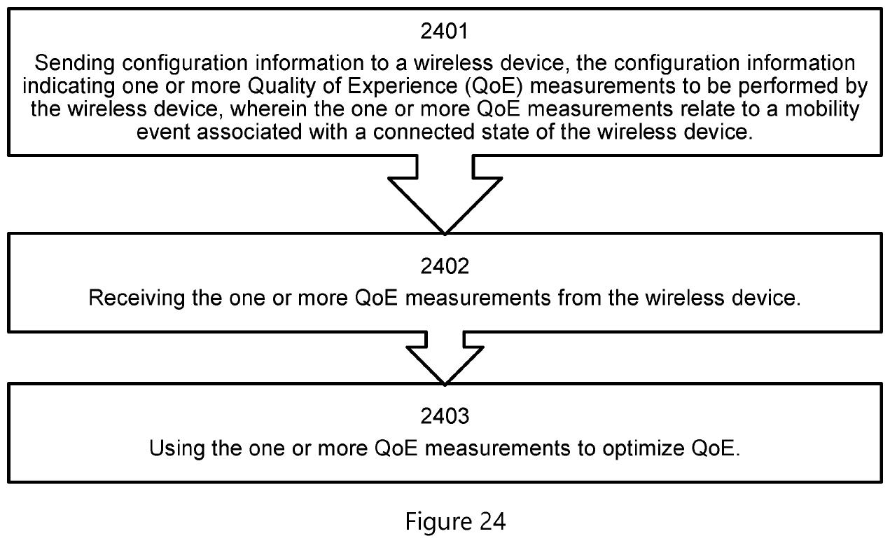

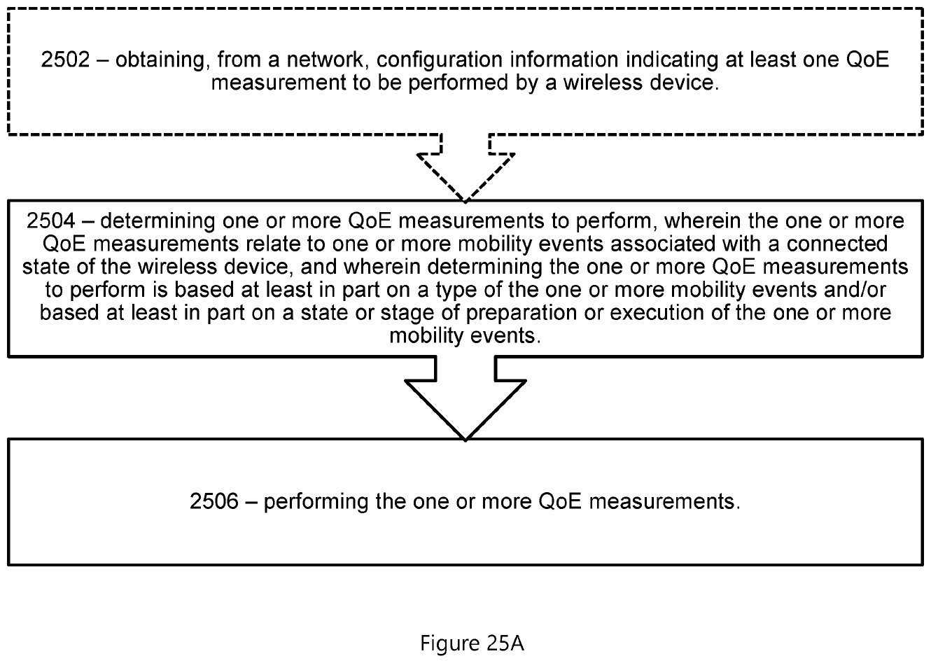

FIG. 24 illustrates an example method in accordance with some embodiments.

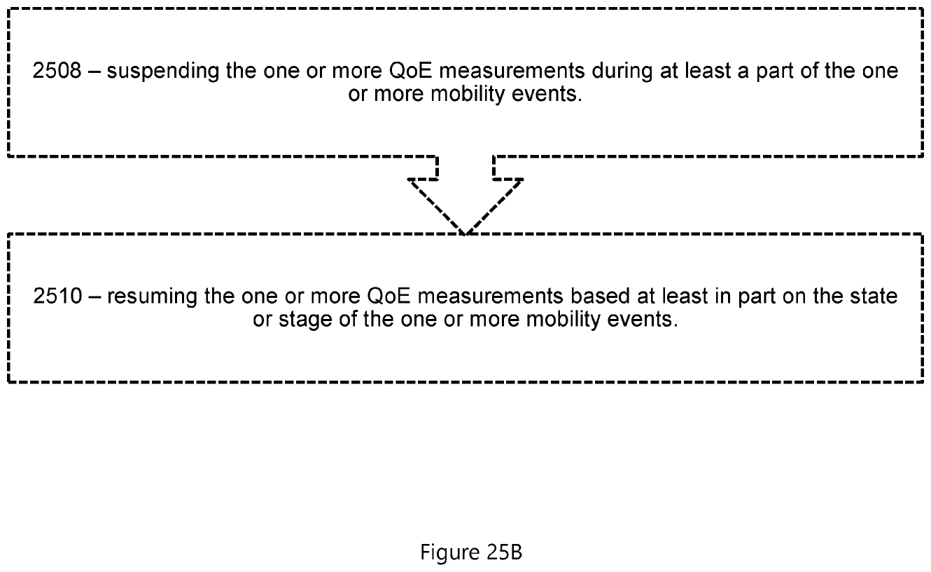

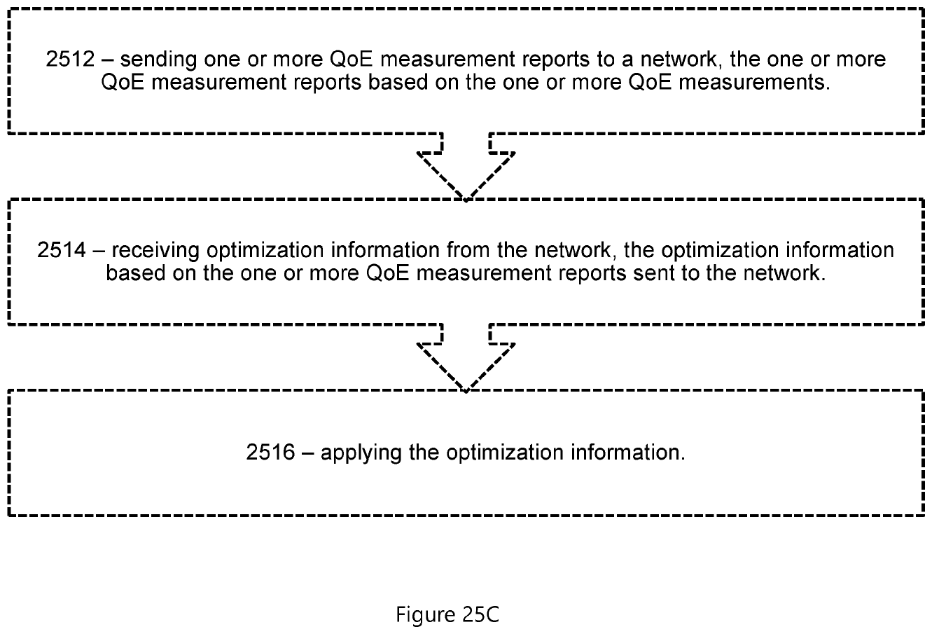

FIGS. 25A-C illustrate example methods in accordance with some embodiments.

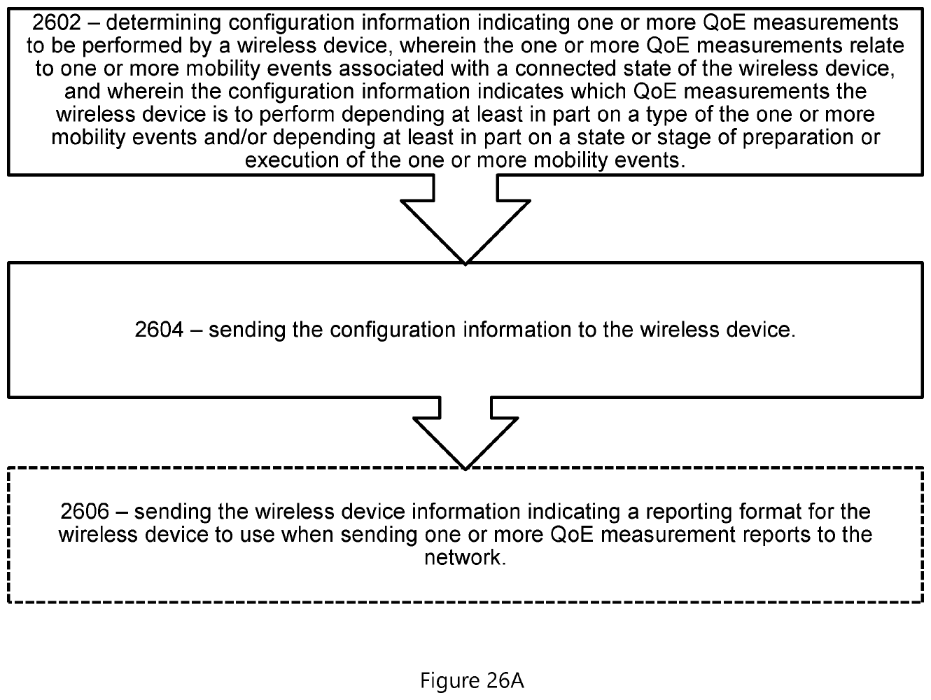

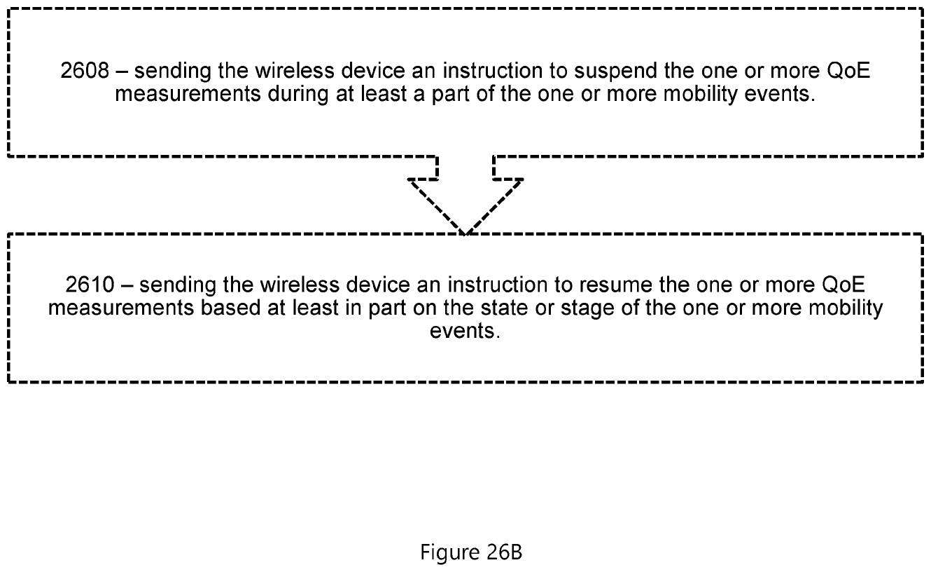

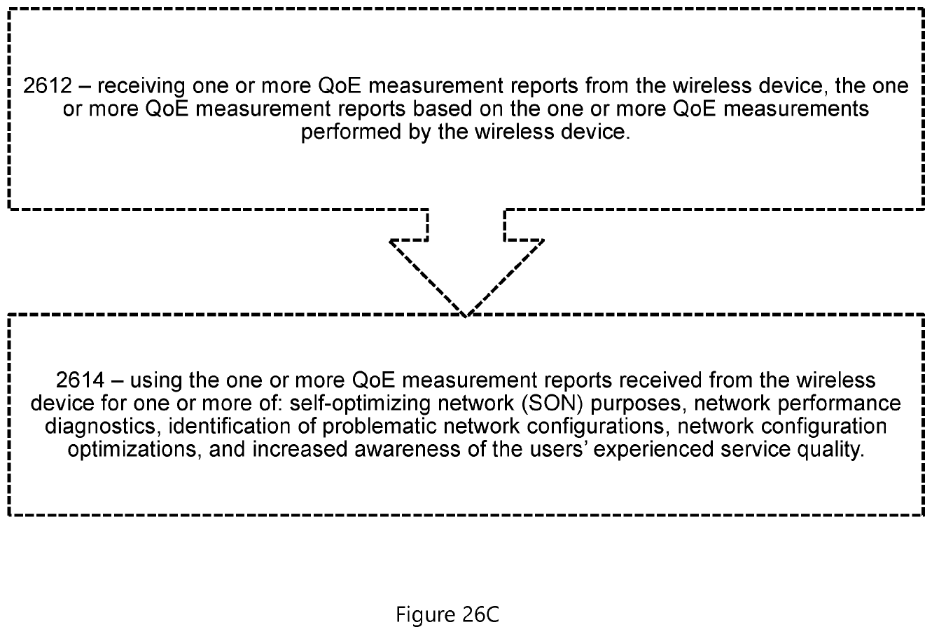

FIGS. 26A-C illustrate example methods in accordance with some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc., are to be interpreted openly as referring to at least one instance of the element apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein mat be applied to any other embodiment, wherever appropriate. Likewise, any advantage of any of the embodiments may apply to any other embodiments, and vice versa. Other objectives, features and advantages of the enclosed embodiments w ill be apparent from the following description.

Some of the embodiments contemplated herein u ill now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The proposed solution is to extend the current QoE measurement configuration framework with further QoE measurement variants, both in terms of the data that is collected (and reported) and in terms of when the measurement data is collected, e.g., what triggers the measurement data collection. In particular, this includes collecting relevant data (i.e., data the network may utilize. e.g., for SON purposes, such as network performance diagnostics, identification of problematic network configurations, network configuration optimizations, and increased awareness of the users' experienced service quality) during RRC_CONNECTED state mobility events, e.g., handovers.

In one embodiment, the source RAN node may configure the UE (e.g., by forwarding QoE measurement configuration information from the CN (e.g., the AMF or the MME) and/or the O&M system) to perform specific QoE measurements or apply specific variations of a QoE measurement configuration in conjunction with a handover and/or special treatment of data collected in conjunction with an RRC_CONNECTED state mobility event. e.g., different ways to report the collected data. This may involve:
Intensification of the QoE measurements. e.g., more frequent QoE measurements or QoE measurement sampling, while the handover is ongoing and optionally also a short time before and/or after the handover execution.
Configuration of alternative or additional QoE measurements, e.g., specifically related to the handover, such as:
   Handover interruption time (e.g., in the form of the value of timer T304 when it was stopped). (Note: Timer T304 supervises the handover execution and if the timer expires before the handover is concluded (or the UE has accessed the target cell), the UE concludes that the handover has failed
   Change in data rate (e.g., before and after the handover and possibly during the handover).
   Application buffer related measurements, such as indication of buffer size or changes in the buffer size during handover or an indication if the buffer is emptied during the handover and the duration of buffer emptiness.
   Experienced/measured delay changes in the application data flow.
   Experienced/measured jitter and jitter duration in the application data flow.
   Experienced/measured corruption duration in the application data now.
Providing the UE with special QoE measurement reporting configuration(s) to be used for the QoE measurement data collected in conjunction with the handover. This may be in the form of a special report format or special parameters to be included in the previously configured report and/or special conditions for transferring a report containing QoE measurement data. e.g., special events for event-triggered reporting or a special reporting frequency
Configuring the UE to suspend QoE measurement(s) (and optionally any associated duration tinier), while a handover is ongoing, e.g., from the triggering of the handover execution until the UE successfully completes the handover in the target node. Herein, triggering of the execution of the handover may e.g., involve, or consist of, reception of the Handover Command (i.e., the RRCReconfiguration message triggering handover execution) in the UE, or, in the case of a Conditional Handover, fulfillment of a handover execution condition. Furthermore, successful completion of the handover may involve, or consist of, successful completion of a random access procedure in the target cell, transmission (with or without confirmed reception) of a Handover Complete message in the target cell (i.e., an RRCReconfigurationComplete message sent in the target cell to indicate completion of the handover), or reception in the UE of a downlink signaling message from the target RAN node, e.g., an RRCReconfiguration message, or signaling of a downlink assignment or an uplink grant on the PDCCH in the target cell after successful transmission of a Handover Complete message in the target cell (i.e., an RRCReconfiguratonComplete message sent in the target cell to indicate completion of the handover) or after successful completion of random access in the target cell. Furthermore, the source RAN node may further configure the UE to, if the concerned handover fails, keep the concerned QoE measurement(s) suspended during any subsequent RRC connection re-establishment procedure. The source node may provide any of these configuration(s) per measured application or for all QoE measurement(s) together.
In case of a DAPS handover, whether the UE should perform QoE measurements on only the source cell/link, only the target cell/link or both the source and target cell/link while the UE is connected in both the source cell and the target cell.

The exact configurations of the above measurement actions may depend on the type of mobility event, since different mobility events have different levels of time criticality. For instance, in addition to the mobility events listed in the disclaimer list above, the exact configuration of the measurements to be performed will depend on whether the UE handover is (a non-limiting set of examples).
Intra-DU (i.e., between two cells served by the same gNB-DU), or
Intra-CU (i.e., between two gNB-DUs controlled by the same gNB-CU), or
Inter-CU (i.e., between two gNB-CUs), or
Intra- or inter-gNB, for non-split RAN nodes, and/or
Intra- or inter-Radio Access Technology (RAT)

The exact measurement configuration may depend on whether or not the UE is served by an Integrated access and backhaul (IAB) network. Moreover, the measurement configurations may also depend on whether the handover is:
Xn-X2-based (i.e., directly between two gNBs that have an Xn/X2 interface established), or
NG/S1-based—when there is no Xn/X2 connection between the source and target gNB/eNB, handover involves the AMF/MME. This type of handover typically takes longer than the Xn/X2-based one.

Although the UE is generally not aware of the network architecture, there are still means for the UE to infer the type of handover event. For instance, the UE knows the Cell Global Identifier (CGI) of the source and target cell. Having in mind that certain bits in the CGI indicate the gNB ID of its gNB, by comparing the source and target CGI the UE realizes that the handover is between two gNBs. Alternatively, the UE may be informed about the handover type by an explicit indication in e.g., handover command.

In the QoE report pertaining to a mobility event, the UE indicates the type of mobility event that took place (e.g., DAPS handover). In case the UE is not aware of which exact mobility event took place, the RAN node can insert in the report the indication of the mobility event.

In one embodiment, the RAN may modify the measurement configuration (as received from the CN/O&M system), based on its knowledge of RAN architecture and/or network topology serving the UE. For example, in IAB networks, the DU serving the UE may be several wireless hops away from the CU, where this “distance” in hops from the CU has a direct impact on QoE during the mobility event, one reason being the fact that the latency of communication with UE is generally larger than for a IE served by a non-IAB network. The RAN node can then configure the measurement parameters for mobility events, based on the knowledge of network topology serving the UE. For instance, the measurement configuration from the O&M system stipulates that the QoE at handover is measured, where the RAN sets the exact values of measurement configuration parameters, such as measurement intervals.

In one embodiment, the network configures the UE to apply the special QoE measurement configuration(s) related to RRC_CONNECTED state mobility event(s) during, or in conjunction with, any upcoming mobility event of the relevant type(s) (at least as long as the QoE measurement configuration is not cancelled or suspended, either through explicit instruction from the network or because the UE moves outside the configured measurement area or because a validity time for the QoE measurement configuration expires, or some other event occurs which triggers cancellation or suspension of the QoE measurements or QoE measurement configuration).

In another embodiment, the network configures the UE to apply the special QoE measurement configurations) related to RRC_CONNECTED state mobility event(s) only in conjunction with a single RRC_CONNECTED state mobility event. As an example, the network may configure the UE to perform handover related QoE measurements in conjunction with a single handover, in which case the configuration may be provided in signaling related to the handover, e.g., in the RR(Reconfiguration message (in NR) or RRCConnectonReconfiguration message (in LTE) constituting the Handover Command. i.e., the message that triggers the UE to execute the handover. In this example, the concerned QoE measurement configuration may be created or included by either the target RAN node (when it creates the HandoverCommand) or the source RAN node (forwarded to the target RAN node in the Handover Request XnAP/X2AP message or inserted in the RRCReconfiguration message, or RRCConnectonReconfiguration message conveying the Handover Command to the UE.

In yet another embodiment, the network configures the UE with special QoE measurement configuration(s) related to RRC_CONNECTED state mobility events to be stored in the UE for the time being (at least as long as the QoE measurement configuration is not cancelled or suspended, either through explicit instruction from the network or because the UE moves outside the configured measurement area or because a validity time for the QoE measurement configuration expires, or some other event occurs which triggers cancellation or suspension of the QoE measurements or QoE measurement configuration), but the configuration is “dormant”/suspended by default and the network activates it on a per RRC_CONNECTED state mobility event basis, e.g., prior to, or in conjunction with, triggering of the concerned RRC_CONNECTED state mobility event.

In yet another embodiment, the network configures the UE with special QoE measurement configuration(s) related to certain type(s) of RRC_CONNECTED state mobility events. This may be combined with any of the above embodiments related to when the concerned QoE measurement configuration is applied.

In another embodiment, the network configures the UE with special QoE measurement configuration(s) considering at least one or a combination of the following factors:
amount of mobility events occurred during a time period;
number of visited cells during a time period;
type of visited cells during a time period.
constellation of the services being used during the mobility evens (e.g., identified by 5QI)
configuration settings of the services subject to handover (e.g., handover thresholds per 5QI)
speed of the UE
radio conditions at the target network node that may constitute a limiting factor for the QoE configuration or the QoE reporting.
   As an example, if the history of mobility events indicates a large number of cells, the network may deduce that a different QoE measurement configuration, with more frequent reporting is preferable compared to the current one.

As additional example, if the history of mobility events indicates a list of visited cells that belong to more than one RAT and the UE has more than one service active, the network may deduce that a different QoE measurement configuration, where the QoE reporting for at least one service considered less important may be excluded in favor or more frequent QoE reporting of other services.

As additional example, if the source network node becomes aware of a high level of uplink interference in the target node prior the handover preparation or handover execution, it may suggest a different QoE measurement configuration, where the QoE reporting is less frequent or paused for a while.

In an embodiment. RAN node sends the area configuration as part of application measurement configuration via RRC signaling to the UE. The information as part of area configuration may include but not limited to.
cell ID (global and/or physical cell ID)
tracking area code.
geographical coordinates and/or shape descriptions.
indication of the network slices

Upon handover and new cell change, the UE checks whether the new serving cell is within the area configured as part of area configuration.
If the new serving cell is within the area configured as pail of area configuration UE sends an indication to application to start the QoE measurements
   If the QoE measurement was suspended for any reason (e.g., previous cell for example source cell of handover was not within the area configured as part of area configuration), the UE sends an indication to the application to resume the QoE measurement
If the new serving cell is NOT within the area configured as part of area configuration UE sends an indication to application to stop the QoE measurements.
   Here is an example implementation of the method with the relevant aspects shown highlighted below (in bold font).

### ***************

| | |
|---|---|
| measConfigAppLayer-r15 | CHOICE { |

| | |
|---|---|
| release | NULL, |
| setup | SEQUENCE{ |

| | |
|---|---|
| measConfigAppLayerContainer-r15 | OCTET STRING (SIZE(1.,1000)), |
| serviceType-r15 | ENUMERATED {qoe, qoemtsi, spare6, |

spare5, spare4, spare3, spare2, spare1}
}
measConfigAppLayerToAddModList-r16 SEQUENCE

| | | |
|---|---|---|
| (SIZE (1.. maxQoE-Measurement-r16)) OF | MeasConfigAppLayer-r16 | OPTIONAL, -- |

Need ON

| measConfigAppLayerToReleaseList-r16 | SEQUENCE | |
|---|---|---|
| (SIZE (1.. maxQoE-Measurement-r16)) OF | MeasReleaseAppLayer-r16 | OPTIONAL -- |

Need ON
MeasConfigAppLayer-r16 ::= SEQUENCE {

| | |
|---|---|
| measConfigAppLayerContainer-r15 OCTET STRING (SIZE(1.. 1000)) | OPTIONAL, -- |

```
Need ON
  serviceType-r16 ServiceType-r16 OPTIONAL, -- Need ON
  qoe-Reference-r16 QoE-Reference-r16 OPTIONAL, -- Need ON
```

| | |
|---|---|
| temporaryStopQoE-r16 | BOOLEAN, |
| restartQoE-r16 | BOOLEAN, |
| qoe-areaConfiguration-r17 | QoE-AreaConfiguration-r17 |

OPTIONAL,
}
MeasReleaseAppLayer-r16 ::= SEQUENCE {

| | |
|---|---|
| serviceType-r16 ServiceType-r16 | OPTIONAL, -- Need ON |
| qoe-Reference-r16 QoE-Reference-r16 | OPTIONAL -- Need ON |

}

| | |
|---|---|
| QoE-AreaConfiguration-r17 ::= | SEQUENCE { |
| cellGlobalIdList-r16 | CellGlobalIdList-r16, |
| trackingAreaCodeList-r16 | TrackingAreaCodeList-r16, |
| trackingAreaIdentityList-r16 | TrackingAreaIdentityList-r16 |

}

| | |
|---|---|
| CellGlobalIdList-r16 ::== | SEQUENCE(SIZE(1..32))OF CGI-Info-Logging-r16 |
| TrackingAreaCodeList-r16 :== | SEQUENCE(SIZE(1..8))OF TrackingAreaCode |

TrackingAreaIdentityList-r16 ::= SEQUENCE(SIZE(1..8))OF TrackingAreaIdentity-
r16

| | |
|---|---|
| TrackingArcaIdentity-r16 ::= | SEQUENCE { |
| plmn-Identity-r16 | PLMN-Identity, |
| trackingAreaCode-r16 | TrackingAreaCode |

}

### ***************

Instead of sending the area scope to the UE, the withinArea indication can be used as described e.g., in P73669. The withinArea indication indicates at each handover whether the new cell is in the area or not with the assumption that the area scope has not been sent to the UE. One problem with the withinArea indication is that the application layer needs to be able to distinguish receiving “no indication” from receiving nothing. Receiving nothing means that the UE is still in the same cell, whereas receiving “no indication” means that the UE has performed a handover but the new cell is not within the area for the measurements. This could e.g., be clarified in 3GPP TS 27.007, by also letting the withinArea indication serve as a handover indication, i.e., informing the application layer that a handover took place. See example update to 3GPP TS 27.007 in yellow:
<within_area>: integer type. Indicates whether the UE is within an area in scope for QoE measurement collection.
0 UE performed a handover and is within area of scope for QoE measurement collection
1 UE performed a handover and is outside area of scope for QoE measurement collection.
   Alternatively, a new indication could be used to inform the application layer that a handover took place.

### Scheduling the QoE Measurement for a Certain Period of Time Upon Mobility

Current QoE management in LTE networks does not support a dynamic schedule for the QoE measurement. It might be interesting for a network operator to define a certain period of time for a UE to collect the QoE report from time T1 to the time T2. This provides more flexibility for network operators to design automatic measurement collection job/task to be executed at RAN level targeting certain period of time. This may be helpful for example for analyzing the QoE measurement in rush hours.
1—In first step of this method RAN node receives a Trace Activation signal (e.g., “TRACE START”) including QoE configuration AMF or O&M or any other management entity in charge of QoE measurement initiation, Trace activation includes a QoE timing information including a start time of the QoE measurement and end time of the QoE configuration
2—The RAN node may send the QoE configuration to other RAN nodes upon mobility over X2, Xn or NG interfaces, so upon mobility to another RAN node and another new serving cells, the new RAN node may initiate the QoE measurements in accordance with the QoE timing information.

In another embodiment, a RAN node mam send the QoE configuration including the timing information (some non-limiting examples of timing information are start time and end time of the measurement) to the UE via MeasConfigAppLayer as part of RRC signaling.

For additional context:
The disclosed embodiments describe a non-limiting example of NR architecture, but the disclosure is equally applicable to the architecture of other RATs (such as LTE)
The terms “Measurement Collector Entity” (MCE) and “Trace Collector Entity” (TCE) are used interchangeably.
The QoE measurement report is delivered to the MCE/TCE, but the entity analysing the report and acting upon it may be another entity in the network (e.g., in the OAM system)
The terms “QoE measurement report”, “measurement report” and “report” are used interchangeably, to refer to the QoE measurement results delivered from the UE to the network
The solution is described mainly with handover as the example RRC_CONNECTED state mobility event, but the embodiments are also applicable other RRC_CONNECTED state mobility events, including at least DAPS handover. Conditional Handover. SCell addition, SCell change, PSCell change, conditional PSCell change (CPC) and master node/secondary node role switch

### Example Network

Although the subject matter described herein may be implemented in any appropriate type of system using any suitable components, the embodiments disclosed herein are described in relation to a wireless network, such as the example wireless network illustrated in the following figures:

For simplicity, the wireless network of FIG. 21) only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth. Z-Wave and/or ZigBee standards.

Network 106 may comprise one or more backhaul networks, core networks. IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network Indifferent embodiments, the wireless network may comprise any number of wired or wireless networks, network nodes, base stations, controllers, wireless devices, relay stations, and/or any other components or systems that may facilitate or participate in the communication of data and/or signals whether, in wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)) Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs) Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs). O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a K ireless device a with access to the wireless network or to provide some service to a wireless device that has accessed the wireless network.

In FIG. 20, network node 160 includes processing circuitry 170, device readable medium 180, interface 190, auxiliary equipment 184, power source 186, power circuitry 187, and antenna 162. Although network node 160 illustrated in the example wireless network of FIG. 20 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc., which may each have their own respective components. In certain scenarios in which network node 160 comprises multiple separate components (e.g., BTS and BSC components), one or more of the separate components may be shared among several network nodes. For example, a single RNC may control multiple NodeB's In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may, be shared b, the RATs). Network node 160 may also include multiple sets of the various illustrated components for different wireless technologies integrated into network node 160, such as, for example, GSM, WCDMA. LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided b, a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc, and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186.

Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 20 that mat be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE) Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaining console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE) a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.) In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuity 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 1 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna III and processing circuitry 120, and is configured to condition signals communicated between antenna 11 and processing circuitry 120. Radio front end circuitry 112 may be coupled to or a part of antenna 111. In some embodiments. WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips In some embodiments. RF transceiver circuitry 122 may be a part of interface 114 RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc., and/or other instructions capable of being executed by processing circuitry 120. Device readable medium 130 may include computer memory (e.g., Random Access Memory (RAM) or Read Only Memory (ROM), mass storage media e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

FIG. 21 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g, a smart power meter). UE 2200 may be any UE identified by the 3^{rd} Generation Partnership Project (3GPP), including a NB-IoT U, a machine type communication (MTC) UE, and/or an enhanced MTC (eMTC) UE. UE 200, as illustrated in FIG. 21, is one example of a WD configured for communication in accordance with one or more communication standards promulgated by the 3^{rd} Generation Partnership Project (3GPP), such as 3GPP's GSM. UMTS, LTE, and/or 5G standards. As mentioned previously, the term WD and UE may be used interchangeable. Accordingly, although FIG. 21 is a UE, the components discussed herein are equally applicable to a WD, and vice-versa.

In FIG. 21. UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, 2b and/or any other component, or any combination thereof. Storage medium 221 includes operating system 223, application program 225, and data 227. In other embodiments, storage medium 221 may include other similar types of information. Certain UEs may utilize all of the components shown in FIG. 21, or only a subset of the components. The level of integration between the components may vary from one UE to another UE Further, certain UEs may contain multiple instances of a component, such as multiple processors, memories, transceivers, transmitters, receivers, etc.

In FIG. 21, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 21. RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET. ATM, or the like Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive. Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a dev ice readable medium.

In FIG. 21, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b.

For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA. GSM, LTE. UTRAN, WiMax, or the like Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication. Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

FIG. 22 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of, virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 22, hardware 330 may be a standalone network node with generic or specific components. Hardware 330 may comprise antenna 3225 and may implement some functions via virtualisation. Alternatively, hardware 330 may be part of a larger cluster of hardware (e.g., such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine Each of virtual machines 340 and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 22.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

FIG. 23 depicts a method in accordance with particular embodiments. In certain embodiments, the method may be performed by a wireless device, such as wireless device 160 (e.g., UE 200) described above. For example, in certain embodiments, processing circuitry 120 (e.g., processor 201 in UE 200) may be configured to perform the steps of the method. The method begins at step 2301 with performing one or more Quality of Experience (QoE) measurements related to a mobility event, wherein the mobility event is associated with a connected state of the wireless device, and continues to step 2302 with sending the one or more QoE measurements to a network. The ‘Group A’ methods described below provide further examples of steps that may be included in the method.

FIG. 24 depicts a method in accordance with particular embodiments. In certain embodiments, the method may be performed by a network node, such as a gNB, eNB. O&M entity, MCE/TCE, or other network node. For example, in certain embodiments, processing circuitry 170 of network node 160 may be configured to perform the steps of the method. The method begins at step 2401 with sending configuration information to a wireless device. The configuration information indicates one or more Quality of Experience (QoE) measurements to be performed by the wireless device. The one or more QoE measurements relate to a mobility event associated with a connected state of the wireless device. At step 2402, the method receives the one or more QoE measurements from the wireless device and at step 2403, the method uses the one or more QoE measurements to optimize QoE. The “Group B” methods described below provide further examples of steps that may be included in the method.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

### EMBODIMENTS

### Group A Embodiments

1. A method performed by a wireless device, the method comprising:
   performing one or more Quality of Experience (QoE) measurements related to a mobility event, wherein the mobility event is associated with a connected state of the wireless device.
2. The method of embodiment 1, further comprising
   sending the one or more QoE measurements to a network.
3. The method of any of embodiments 1-2, further comprising:
   using the one or more QoE measurements to optimize QoE at the wireless device.
4. The method of any of embodiments 1-3, further comprising:
   prior to performing the one or more QoE measurements, obtaining configuration information from the network, the configuration information indicating at least one of the QoE measurements to be performed by the wireless device
5. The method of any of embodiments 1-4, further comprising:
   prior to performing the one or more QoE measurements, determining which QoE measurements to perform.
6. The method of embodiment 5, wherein determining which QoE measurements to perform is based at least in part on a type of the mobility event.
7. The method of embodiment 5, wherein determining which QoE measurements to perform is based at least in part on a state or stage of execution of the mobility event.
8. The method of any of embodiments 1-7, wherein the mobility event is one of: handover, DAPS handover, Conditional Handover, SCell addition, SCell change, PSCell change, conditional PSCell change (CPC), and master node/secondary node role switch.
9. The method of an, of embodiments 1-8, wherein at least one of the QoE measurements indicates a performance of an execution of the mobility event.
10. The method of any of embodiments 1-9. % wherein at least one of the QoE measurements indicates a consequence of an execution of the mobility event on one or more other performance aspects relevant to QoE.
11. The method of embodiment 10, wherein at least one of the other performance aspects indicates at least one of handover interruption time, change of data rate in conjunction with a mobility event, buffer related data, change of buffer content size, measured latency, or measured jitter.
12 The method of any of embodiments 1-11, further comprising: suspending the one or more QoE measurements while the mobility event is ongoing.
13. The method of embodiment 12, wherein suspending the one or more QoE measurements is in response to an instruction from the network.
14 The method of any of embodiments 1-13, wherein the mobility event is a handover during which the wireless device connects to a source cell via a source link and to a target cell via a target link, and wherein the method. Further comprises determining whether to perform the one or more QoE measurements on the source link, the target link, or both.
15. The method of embodiment 14, wherein the determining whether to perform the one or more QoE measurements on the source link, the target link, or both is based on configuration information received from the network.
16. The method of any of embodiments 1-15, wherein sending the one or more QoE measurements to the network is according to a reporting format requested by the network.
17 The method of any of embodiments 1-16, further comprising:
   receiving optimization information from the network, the optimization information based on the one or more QoE measurements sent to the network; and
   applying the optimization information.
18. The method of any of the previous embodiments, further comprising:
   providing user data; and
   forwarding the user data to a host computer via the transmission to the base station.

### Group B Embodiments

19. A method performed by a network node, the method comprising:
   sending configuration information to a wireless device, the configuration information indicating one or more Quality of Experience (QoE) measurements to be performed by the w ireless device, wherein the one or more QoE measurements relate to a mobility event associated with a connected state of the wireless device.
20. A method performed by a network node (or, alternatively, the method of embodiment 19), the method comprising:
   receiving one or more QoE measurements from a wireless device, the one or more QoE measurements relating to a mobility event associated with a connected state of the wireless device
21. The method of any of embodiments 19-20, further comprising.
   using the one or more QoE measurements to optimize QoE.
22. The method of any of embodiments 19-21, further comprising.
   prior to sending the configuration information, determining the configuration information to send to the wireless device
23. The method of any of embodiments 19-22, wherein the configuration information indicates which QoE measurements to perform depending at least in part on a type of the mobility event.
24 The method of any of embodiments 19-23, wherein the configuration information indicates which QoE measurements to perform depending at least in part on a state or stage of execution of the mobility event.
25. The method of any of embodiments 19-24, wherein the mobility event is one of: handover. DAPS handover, Conditional Handover. SCell addition, SCell change, PSCell change, conditional PSCell change (CPC), and master node/secondary node role switch
26. The method of any of embodiments 19-25, wherein at least one of the QoE measurements indicates a performance of an execution of the mobility event.
27. The method of any of embodiments 19-26, wherein at least one of the QoE measurements indicates a consequence of an execution of the mobility event on one or more other performance aspects relevant to QoE.
28. The method of embodiment 27, a herein at least one of the other performance aspects indicates at least one of: handover interruption time, change of data rate in conjunction with a mobility event, buffer related data, change of buffer content size, measured latency, or measured jitter.
29. The method of any of embodiments 19.28, further comprising: sending the wireless device an instruction to suspend the one or more QoE measurements while the mobility event is ongoing
30. The method of embodiment 29, wherein the instruction to suspend the one or more QoE measurements is sent with the configuration information.
31. The method of embodiment 29, w herein the instruction to suspend the one or more QoE measurements is sent independently of the configuration information.
32. The method of any of embodiments 19-31, wherein the mobility event is a handover during which the wireless device connects to a source cell via a source link and to a target cell via a target link, and wherein the configuration information indicates whether to perform the one or more QoE measurements on the source link, the target link, or both.
33. The method of any of embodiments 19-32, further comprising.
   sending the wireless device information indicating a reporting format for the wireless device to use when sending the QoE measurements to the network.
34. The method of any of embodiments 19-33, further comprising:
   determining optimization information, the optimization information based on the one or more QoE measurements received from the wireless device.
35 The method of embodiment 34, further comprising:
   applying the optimization information.
36. The method of any of embodiments 34-35, further comprising:
   sending the optimization information to be applied by the wireless device, to another network node, or both.
37. The method of any of embodiments 19-36, further comprising
   using the one or more QoE measurements received from the wireless device for one or more of: self-optimizing network (SON) purposes, network performance diagnostics, identification of problematic network configurations, network configuration optimizations, and increased awareness of the users' experienced service quality.
38. The method of any of the previous embodiments, further comprising:
   obtaining user data; and
   forwarding the user data to a host computer or a wireless device.

### Group C Embodiments

39. A wireless device, the wireless device comprising.
   processing circuitry configured to perform any of the steps of any of the Group A embodiments, and
   power supply circuitry configured to supply power to the wireless device.
40. A base station, the base station comprising.
   processing circuitry configured to perform any of the steps of any of the Group B embodiments;
   power supply circuitry configured to supply power to the base station.
41. A user equipment (UE), the UE comprising.
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the U E that has been processed by the processing circuitry, and
   a battery connected to the processing circuitry and configured to supply power to the UE.
42. A computer program, the computer program comprising instructions which when executed on a computer perform any of the steps of any of the Group A embodiments.
43. A computer program product comprising a computer program, the computer program comprising instructions which when executed on a computer perform any of the steps of any of the Group A embodiments.
44. A non-transitory computer-readable storage medium or carrier comprising a computer program, the computer program comprising instructions which when executed on a computer perform any of the steps of any of the Group A embodiments.
45. A computer program, the computer program comprising instructions which when executed on a computer perform any of the steps of any of the Group B embodiments.
46. A computer program product comprising a computer program, the computer program comprising instructions which when executed on a computer perform any of the steps of any of the Group B embodiments.
47. A non-transitory computer-readable storage medium or carrier comprising a computer program, the computer program comprising instructions which when executed on a computer perform any of the steps of any of the Group B embodiments.
48. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
49. The communication system of the pervious embodiment further including the base station.
50 The communication system of the previous 2 embodiments, further including the UE, wherein the UE is configured to communicate with the base station.
51. The communication system of the previous 3 embodiments, wherein:
   the processing circuitry of the host computer is configured to execute a host application, thereby providing the user data; and
   the UE comprises processing circuitry configured to execute a client application associated with the host application.
52. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
53. The method of the previous embodiment, further comprising, at the base station, transmitting the user data.
54. The method of the previous 2 embodiments, wherein the user data is provided at the host computer by executing a host application, the method further comprising, at the UE, executing a client application associated with the host application.
55. A user equipment (UE) configured to communicate with a base station, the UE comprising a radio interface and processing circuitry configured to performs the of the previous 3 embodiments
56. A communication system including a host computer comprising:
   processing circuitry configured to provide user data, and
   a communication interface configured to forward user data to a cellular network for transmission to a user equipment (UE),
   wherein the UE comprises a radio interface and processing circuitry, the UE's components configured to perform any of the steps of any of the Group A embodiments.
57. The communication system of the previous embodiment, wherein the cellular network further includes a base station configured to communicate with the UE.
58. The communication system of the previous 2 embodiments, w herein:
   the processing circuitry of the host computer is configured to execute a host application, thereby providing the user data; and
   the UE's processing circuitry is configured to execute a client application associated with the host application.
59. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
60. The method of the previous embodiment, further comprising at the UE, receiving the user data from the base station.
61. A communication system including a host computer comprising:
   communication interface configured to receive user data originating from a transmission from a user equipment (UE) to a base station.
   wherein the UE comprises a radio interface and processing circuitry the UE's processing circuitry configured to perform any of the steps of any of the Group A embodiments.
62. The communication system of the previous embodiment, further including the UE.
63. The communication system of the previous 2 embodiments, further including the base station, wherein the base station comprises a radio interface configured to communicate with the UE and a communication interface configured to forward to the host computer the user data carried by a transmission from the UE to the base station.
64. The communication system of the previous 3 embodiments, wherein:
   the processing circuitry of the host computer is configured to execute a host application; and
   the UE's processing circuiting is configured to execute a client application associated with the host application, thereby providing the user data
65. The communication system of the previous 4 embodiments, wherein
   the processing circuitry of the host computer is configured to execute a host application, thereby providing request data; and
   the UE's processing circuitry is configured to execute a client application associated with the host application, thereby providing the user data in response to the request data.
66. A method implemented in a communication system including a host computer, a base station and a user equipment (UE), the method comprising:
   at the host computer, receiving user data transmitted to the base station from the UE, wherein the UE performs any of the steps of an, of the Group A embodiments.
67. The method of the previous embodiment, further comprising, at the UE, providing the user data to the base station.
68. The method of the previous 2 embodiments, further comprising.
   at the UE, executing a client application, thereby providing the user data to be transmitted; and
   at the host computer, executing a host application associated with the client application
69. The method of the previous 3 embodiments, further comprising
   at the UE, executing a client application, and
   at the UE, receiving input data to the client application, the input data being, provided at the host computer by executing a host application associated with the client application.
   wherein the user data to be transmitted is provided by the client application in response to the input data.
70. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
71. The communication system of the previous embodiment further including the base station.
72. The communication system of the previous 2 embodiments, further including the UE, wherein the UE is configured to communicate with the base station.
73. The communication system of the previous 3 embodiments, wherein:
   the processing circuitry of the host computer is configured to execute a host application,
   the UE is configured to execute a client application associated with the host application, thereby providing the user data to be received by the host computer.
74. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
75 The method of the previous embodiment, further comprising at the base station, receiving the user data from the UE.
76. The method of the previous 2 embodiments, further comprising at the base station, initiating a transmission of the received user data to the host computer.

FIGS. 25A-C illustrate example methods in accordance with some embodiments. The methods of FIGS. 25A-C may be performed by a wireless device, such as wireless device 110 or UE 200 described above. For example, the wireless device may comprise processing circuitry (e.g., processing circuitry 120 or processor 201) configured to perform steps of the methods.

As shown in FIG. 25A, certain embodiments may begin at step 2502 with obtaining configuration information from a network. The configuration information indicates at least one QoE measurement to be performed by the wireless device. Certain embodiments may then proceed to step 2504. Other embodiments may omit step 2502 and may begin at step 2504. At step 2504, the method determines one or more QoE measurements to perform. The one or more QoE measurements relate to one or more mobility events associated with a connected state of the wireless device. For example, in certain embodiments, at least one of the one or more mobility events is one of: handover. DAPS handover, Conditional Handover. SCell addition, SCell change. PSCell change. CPC, and master node/secondary node role switch.

Determining the one or more QoE measurements to perform is based at least in part on a type of the one or more mobility events and/or based at least in part on a state or stage of preparation or execution of the one or more mobility events. Thus, certain embodiments determine the one or more QoE measurements to perform based at least in part on the type of the one or more mobility events, certain embodiments determine the one or more QoE measurements to perform based at least in part on the state or stage of preparation or execution of the one or more mobility events, and certain embodiments determine the one or more QoE measurements to perform based at least in part on both of the preceding.

In certain embodiments, at least one of the mobility events may be a handover during which the wireless device connects to a source cell via a source link and to a target cell via a target link. The method may further comprise determining whether to perform the one or more QoE measurements on the source link, the target link, or both Certain embodiments determine whether to perform the one or more QoE measurements on the source link, the target link, or both based on configuration information received from the network.

The method proceeds to step 2506 with performing the one or more QoE measurements determined in step 2504.

Optionally, certain embodiments may further include one or more steps show n in FIG. 25B and/or one or more steps shown in FIG. 25C Turning to FIG. 25B, step 2508 illustrates suspending the one or more QoE measurements during at least a part of the one or more mobility events. As an example, certain embodiments may suspend the QoE measurements while an RRC_CONNECTED state mobility event is ongoing. Certain embodiments suspend the one or more QoE measurements is in response to an instruction form the network. The method may further include resuming the one or more QoE measurements, as shown in step 2510. As an example, resuming the one or more QoE measurements may be based at least in part on the state or stage of the one or more mobility events. As another example, certain embodiments may resume the one or more QoE measurements based at least in part on expiry of a duration timer associated with suspending the one or more QoE measurements. For example, an instruction to suspend the one or more QoE measurements received from the network may indicate the duration timer associated with suspending the one or more QoE measurements.

Turning to FIG. 25C, certain embodiments further comprise sending one or more QoE measurement reports to a network, as show n in step 2512. The one or more QoE measurement reports are based on the one or more QoE measurements performed in step 2506 and/or step 2510. As an example, at least one QoE measurement report may indicate an occurrence of the one or more mobility events. As another example, at least one QoE measurement report may indicate an impact of the one or more mobility events on at least one of handover interruption time, data rate, buffer related data, buffer content size, measured latency, or measured jitter Certain embodiments send the one or more QoE measurement reports to the network according to a reporting format requested by the network.

Optionally, at step 2514, the method receives optimization information from the network. The optimization information is based on the one or more QoE measurement reports sent to the network in step 2512. At step 2516, the method applies the optimization information received in step 2514.

In an alternative embodiment, the network may use the one or more QoE measurement reports sent in step 2512 for purposes other than providing optimization information to the wireless device. Thus, steps 2514 and 2516 may be omitted in such cases. Examples of other ways the network may use the QoE measurement reports are described below with respect to step 2614 of FIG. 26C.

FIGS. 26A-C illustrate example methods in accordance with some embodiments. The methods of FIGS. 26A-C may be performed by a network node, such as network node 160 described above. For example, the network node may comprise processing circuitry (e.g. processing circuitry 170) configured to perform steps of the methods.

In certain embodiments, the method begins at step 2602 of FIG. 26A with determining configuration information indicating one or more QoE measurements to be performed by a wireless device. The one or more QoE measurements relate to one or more mobility events associated with a connected state of the wireless device. For example, in certain embodiments, at least one of the one or more mobility events is one of handover, DAPS handover, Conditional Handover, SCell addition, SCell change, PSCell change, CPC, and master node/secondary node role switch. The configuration information indicates which QoE measurements the wireless device is to perform depending at least in part on a type of the one or more mobility events and/or depending at least in part on a state or stage of preparation or execution of the one or more mobility events. Thus, in certain embodiments the configuration information indicates which QoE measurements the w ireless device is to perform depending at least in part on a type of the one or more mobility events, in certain embodiments the configuration information indicates which QoE measurements the wireless device is to perform depending at least in part on a state or stage of preparation or execution of the one or more mobility events, and in certain embodiments the configuration information indicates which QoE measurements the wireless device is to perform depending at least in part on both of the preceding.

In certain embodiments, at least one of the one or more mobility events is a handover during which the wireless device connects to a source cell via a source link and to a target cell via a target link. In such embodiments, the configuration information may indicate whether to perform the one or more QoE measurements on the source link, the target link, or both.

The method proceeds to step 2604 with sending the wireless device the configuration information determined in step 2602. Optionally, certain embodiments may send the wireless device information indicating a reporting format for the wireless device to use when sending one or more QoE measurement reports to the network, as shown in step 2606. The reporting information may be sent with the configuration information or separately.

Optionally, certain embodiments may further include one or more steps shown in FIG. 26B and/or one or more steps shown in FIG. 26C. Turning to FIG. 26B, step 2608 illustrates sending the wireless device an instruction to suspend the one or more QoE measurements during at least a part of the one or more mobility events. As an example, if a concerned handover fails, a network node (e.g., source RAN node) may instruct the wireless device to suspend the concerned QoE measurement(s) during any subsequent RRC connection re-establishment procedure. The source node may provide the instruction(s) per measured application or for all QoE measurement(s) together. Certain embodiments send the instruction to suspend the one or more QoE measurements with the configuration information of step 2604.

Other embodiments send the instruction to suspend the one or more QoE measurements independently of the configuration information sent in step 2604.

Certain embodiments instruct the wireless device to resume the one or more QoE measurements. As an example, certain embodiments send the wireless device a duration timer associated with the instruction to suspend the one or more QoE measurements. The wireless device may resume the one or more QoE measurements based at least in part on expiry of the duration timer. As another example, certain embodiments send the wireless device an instruction to resume the one or more QoE measurements based at least in part on the state or stage of the one or more mobility events, as shown in step 2610.

Turning to FIG. 26C, certain embodiments receive one or more QoE measurement reports from the wireless device at step 2612. The one or more QoE measurement reports are based on the one or more QoE measurements performed by the w ireless device. As an example, at least one QoE measurement report may indicate an occurrence of the one or more mobility events. As another example, at least one QoE measurement report may indicate an impact of the one or more mobility events on at least one of: handover interruption time, data rate, buffer related data, buffer content size, measured latency, or measured jitter.

At step 2614, the method uses the one or more QoE measurement reports received from the wireless device. For example, the one or more QoE measurement reports may be used for one or more of: self-optimizing network (SON) purposes, network performance diagnostics, identification of problematic network configurations, network configuration optimizations, and increased awareness of the users' experienced service quality. Certain embodiments determine optimization information based on the one or more QoE measurement reports received from the wireless device Certain embodiments further comprise applying the optimization information at the network node and/or sending the optimization information to be applied by the wireless device, sending the optimization information to be applied by another network node, or both.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components.

Additionally, operations of the systems and apparatuses may be performed using any suitable logic comprising software, hardware, and/or other logic. As used in this document, each refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the following claims.

1. A method performed by a wireless device, the method comprising:
determining one or more Quality of Experience (QoE) measurements to perform, wherein the one or more QoE measurements relate to one or more mobility events associated with a connected state of the wireless device, and wherein determining the one or more QoE measurements to perform is based at least in part on a type of the one or more mobility events and/or based at least in part on a state or stage of preparation or execution of the one or more mobility events; and
performing the one or more QoE measurements.

2. The method of claim 1, further comprising:
prior to performing the one or more QoE measurements, obtaining configuration information from the network, the configuration information indicating at least one QoE measurement to be performed by the wireless device.

3. The method of claim 1, wherein at least one of the one or more mobility events is one of: handover, DAPS handover, Conditional Handover, SCell addition, SCell change, PSCell change, conditional PSCell change (CPC), and master node/secondary node role switch.

4.-17. (canceled)

18. A wireless device, the wireless device comprising:
power supply circuitry configured to supply power to the wireless device; and
processing circuitry configured to:
determine one or more Quality of Experience (QoE) measurements to perform, wherein the one or more QoE measurements relate to one or more mobility events associated with a connected state of the wireless device, and wherein determining the one or more QoE measurements to perform is based at least in part on a type of the one or more mobility events and/or based at least in part on a state or stage of preparation or execution of the one or more mobility events; and
perform the one or more QoE measurements.

19. The wireless device of claim 18, the processing circuitry further configured to:
obtain configuration information from the network, the configuration information indicating at least one QoE measurement to be performed by the wireless device, the configuration information obtained prior to performing the one or more QoE measurements.

20. The wireless device of claim 18, wherein at least one of the one or more mobility events is one of: handover, DAPS handover, Conditional Handover, SCell addition, SCell change, PSCell change, conditional PSCell change (CPC), and master node/secondary node role switch.

21. The wireless device of claim 18, the processing circuitry further configured to:
suspend the one or more QoE measurements during at least a part of the one or more mobility events.

22. The wireless device of claim 21, the processing circuitry further configured to:
resume the one or more QoE measurements based at least in part on the state or stage of the one or more mobility events.

23. The wireless device of claim 18, wherein at least one of the one or more mobility events is a handover during which the wireless device connects to a source cell via a source link and to a target cell via a target link, and wherein the processing circuitry is further configured to determine whether to perform the one or more QoE measurements on the source link, the target link, or both.

24. The wireless device of claim 18, the processing circuitry further configured to:
send one or more QoE measurement reports to a network, the one or more QoE measurement reports based on the one or more QoE measurements.

25. The wireless device of claim 24, the processing circuitry further configured to:
receive optimization information from the network, the optimization information based on the one or more QoE measurement reports sent to the network; and
apply the optimization information.

26. A network node, the network node comprising:
power supply circuitry configured to supply power to the network node; and
processing circuitry configured to:
determine configuration information indicating one or more Quality of Experience (QoE) measurements to be performed by a wireless device, wherein the one or more QoE measurements relate to one or more mobility events associated with a connected state of the wireless device, and wherein the configuration information indicates which QoE measurements the wireless device is to perform depending at least in part on a type of the one or more mobility events and/or depending at least in part on a state or stage of preparation or execution of the one or more mobility events; and
send the configuration information to the wireless device.

27. The network node of claim 26, wherein at least one of the one or more mobility events is one of: handover, DAPS handover, Conditional Handover, SCell addition, SCell change, PSCell change, conditional PSCell change (CPC), and master node/secondary node role switch.

28. The network node of claim 26, the processing circuitry further configured to:
send the wireless device an instruction to suspend the one or more QoE measurements during at least a part of the one or more mobility events.

29. The network node of claim 28, the processing circuitry further configured to:
send the wireless device a duration timer associated with the instruction to suspend the one or more QoE measurements.

30. The network node of claim 28, the processing circuitry further configured to:
send the wireless device an instruction to resume the one or more QoE measurements based at least in part on the state or stage of the one or more mobility events.

31. The network node of claim 26, wherein at least one of the one or more mobility events is a handover during which the wireless device connects to a source cell via a source link and to a target cell via a target link, and wherein the configuration information indicates whether to perform the one or more QoE measurements on the source link, the target link, or both.

32. The network node of claim 26, the processing circuitry further configured to:
send the wireless device information indicating a reporting format for the wireless device to use when sending one or more QoE measurement reports to the network.

33. The network node of claim 26, the processing circuitry further configured to:
receive one or more QoE measurement reports from the wireless device, the one or more QoE measurement reports based on the one or more QoE measurements performed by the wireless device.

34. The network node of claim 33, the processing circuitry further configured to:
use the one or more QoE measurement reports received from the wireless device for one or more of: self-optimizing network (SON) purposes, network performance diagnostics, identification of problematic network configurations, network configuration optimizations, and increased awareness of the users' experienced service quality.
